(19) United States
(12) Patent Application Publication
(10) Pub. No.: US 2026/0168803 A1
(43) Pub. Date: Jun. 18, 2026

(54) MOBILITY SERVICE PROVIDING SYSTEM AND A MOBILITY SERVICE PROVIDING METHOD

(71) Applicants: HYUNDAI MOTOR COMPANY, Seoul (KR); KIA CORPORATION, Seoul (KR)

(72) Inventors: Yuri Myoung, Hwaseong-si (KR); Min Young Lee, Hwaseong-si (KR); Dong Hyun Kim, Hwaseong-si (KR); Jeong Chul Jung, Hwaseong-si (KR); Hun Kee Kim, Hwaseong-si (KR)

(73) Assignees: HYUNDAI MOTOR COMPANY, Seoul (KR); KIA CORPORATION, Seoul (KR)

(21) Appl. No.: 19/364,163

(22) Filed: Oct. 21, 2025

(30) Foreign Application Priority Data
Dec. 16, 2024 (KR) 10-2024-0187014

(51) Int. Cl. G01C 21/34; B60L 53/66; G06Q 30/0283

(52) U.S. Cl. CPC G01C 21/3469; B60L 53/665; G01C 21/3476; G06Q 30/0284

(57) ABSTRACT

A mobility service providing system includes a communication interface configured to receive a call command requesting transportation of a place module by a mobility module from a call location to a destination. The mobility service providing system also includes a processor confgured to: determine a required electric energy for travel from the call location to the destination; determine a charging electric energy that the place module is provide to the mobility module; determine a plurality of candidate mobility modules within a predetermined distance of the call location; determine a target mobility module as a final mobility module based on determining that a residual electric energy of the target mobility module satisfies a predetermined reference value condition; determine an estimated charge for the call command based comparing the required electric energy and the charging electric energy; and transmit a call signal to the final mobility module based on the estimated charge.

### CROSS-REFERENCE TO RELATED APPLICATION

This application claims priority to and the benefit of Korean Patent Application No. 10-2024-0187014 filed with the Korean Intellectual Property Office on Dec. 16, 2024, the entire contents of which are hereby incorporated herein by reference.

### BACKGROUND

### (a) Technical Field

The present disclosure relates to a mobility service providing system and a mobility service providing method.

### (b) Description of the Related Art

Today's automobiles used as a transportation means include a space where a user boards and a driving unit that drives wheels. Discussions are being held on connected mobility services that separate a space where a user boards and a driving unit of such automobiles into a place module and a mobility module.

A taxi call service utilizes a system in which a fee is incurred according to the amount of fuel consumed while a customer boards a taxi and travels to a destination.

### SUMMARY

Aspects of the present disclosure provide a mobility service providing system and a mobility service providing method that provide electricity to a mobility module and calculate fees according to the provided electricity.

According to an embodiment, a mobility service providing system is provided. The mobility service providing system includes a communication interface configured to receive, from a user terminal, a call command requesting transportation of a place module by a mobility module from a call location to a destination. The mobility service providing system also includes a processor configured to determine a required electric energy for travel from the call location to the destination. The processor is also configured to determine a charging electric energy that the place module is to provide to the mobility module. The processor is also configured to determine a plurality of candidate mobility modules within a predetermined distance of the call location and determine a target mobility module, among the plurality of candidate mobility modules, as a final mobility module based on determining that a residual electric energy of the target mobility module satisfies a predetermined reference value condition. The processor is further configured to determine an estimated charge for the call command based on a result of comparing the required electric energy and the charging electric energy and transmit a call signal to the final mobility module based on the estimated charge.

The processor may be configured to, based on determining that the charging electric energy is less than or equal to the required electric energy, determine the estimated charge by adding i) a value obtained by multiplying a value obtained by subtracting the charging electric energy from the required electric energy by predetermined additional charge rate per unit electric energy to ii) a predetermined basic charge.

The processor may be configured to, based on determining that the charging electric energy is greater than the required electric energy, the determine an additional charging amount that the place module is to provide to the final mobility module as a smallest value among a value obtained by multiplying a travel time from the call location to the destination by a predetermined charging amount per hour, a value obtained by subtracting required electric energy from the charging electric energy, and a value obtained by subtracting residual electric energy of the final mobility module and the required electric energy corresponding to travel from a current location of the final mobility module to the call location from a maximum charging amount of a predetermined mobility module. The processor may be configured to determine the estimated charge by multiplying the charging amount by a predetermined charging discount charge rate from a predetermined basic charge.

The processor may be configured to determine a candidate mobility module that is located closest to the call location among the plurality of candidate mobility modules as the target mobility module. The processor may be configured to collect a first residual electric energy of the target mobility module from the target mobility module and determine a first travel distance, a first travel time, and a first required electric energy corresponding to the first travel distance and the first travel time from the current location of the target mobility module to the call location. The processor may be configured to determine whether to select the target mobility module as the final mobility module based on determining whether i) a first value obtained by subtracting the first required electric energy and electric energy corresponding to a minimum state of charge (SoC) of the predetermined mobility module from the first residual electric energy is less than ii) a second value obtained by subtracting the charging electric energy from the required electric energy, based on determining that the first travel distance is less than or equal to a predetermined maximum service distance.

The processor may be configured to, based on determining that the first value is less than the second value, determine remaining candidate mobility modules, among the plurality of the candidate mobility modules, excluding the target mobility module as a plurality of new candidate mobility modules. The processor may be configured to determine the mobility module located closest to the call location among the plurality of new candidate mobility modules as a new target mobility module.

The processor may be configured to, based on determining that the first value is greater than or equal to the second value, determine the target mobility module as the final mobility module.

The processor may be configured to, based on receiving, from the user terminal, a response indicating that power of the place module is to be used for the transportation of the place module, determine the charging electric energy by subtracting indoor power consumption of the place module during the travel and a residual target electric energy at the destination from residual electric energy of the place module.

The processor may be configured to determine an indoor power mode of the place module as one of a low-power mode, an intermediate mode, and a high-power mode according to power consumption of internal devices installed inside the place module. The processor may be configured to determine the indoor power consumption by multiplying a travel time from the call location to the destination by a predetermined reference average electric energy according to the indoor power mode. A first reference average electric energy corresponding to the indoor power mode being the low-power mode may be less than a second reference average electric energy corresponding to the indoor power mode being the intermediate mode. The second reference average electric energy may be less than a third reference average electric energy corresponding to the indoor power mode being the high-power mode.

The processor may be configured to determine a driving mode based on information received from the user terminal and determine the residual target electric energy based on the driving mode, the indoor power consumption, the required electric energy, and a minimum target SoC received from the user terminal. The driving mode may be one of a one-way mode for moving from the call location to the destination, a round-trip mode for moving from the call location to the destination and returning to the call location, and a stay mode for moving from the call location to the destination, staying at the destination for a stay time, and returning from the destination to the call location.

The processor may be configured to, based on determining that the driving mode is the one-way mode, determine the residual target electric energy as electric energy corresponding to the minimum target SoC.

The processor may be configured to, based on determining that the driving mode is the round-trip mode, determine the residual target electric energy as a value obtained by subtracting electric energy corresponding to a predetermined reference SoC from a sum of the indoor power consumption, the required electric energy, and electric energy corresponding to the minimum target SoC.

The processor may be configured to, based on determining that the driving mode is the stay mode, the determine power consumption during the stay time by multiplying the stay time by a predetermined reference average electric energy according to a stay type being one of a low-power mode, an intermediate mode, and a high-power mode. The processor may be configured to determine the residual target electric energy by subtracting the electric energy corresponding to the predetermined reference SoC from the sum of the power consumption during the stay time, the indoor power consumption, the required electric energy, and electric energy corresponding to the minimum target SoC. The processor may be configured to determine the power consumption during the stay time by multiplying the stay time by a predetermined reference average electric energy according to the stay mode. A first reference average electric energy corresponding to the stay type being the low-power mode may be less than a second reference average electric energy corresponding to the stay type being the intermediate mode. The second reference average electric energy may be less than a third reference average electric energy corresponding to the stay type being the high-power mode.

According to another embodiment, a service providing system is provided. The service providing system includes a user interface configured to operate on a user terminal, the user interface configured to receive a call command, input by a user, requesting to transport a place module by a mobility module from a call location to a destination. The service providing system also includes a processor of the user terminal. The processor is configured to determine required electric energy for travel from the call location to the destination and determine charging electric energy that the place module is to provide to the mobility module. The processor is also configured to receive, from a control server, a signal indicating a plurality of candidate mobility modules within a predetermined distance of the call location. The processor is further configured to determine a target mobility module, among the plurality of candidate mobility modules, as a final mobility module based on determining that residual electric energy of the target mobility module satisfies a predetermined reference value condition. The processor is further configured to determine an estimated charge for the call command based on a result of comparing the required electric energy and the charging electric energy and transmit a call signal to the final mobility module based on the estimated charge.

According to still another embodiment, a mobility service providing method is provided. The mobility service providing method includes receiving, by a processor, a signal indicating a call command from a user terminal, the call command requesting to transport a place module by a mobility module from a call location to a destination. The mobility service providing method also includes determining, by the processor, required electric energy for travel from the call location to the destination and determining charging electric energy to be provided by the place module to the mobility module. The mobility service providing method further includes determining a plurality of candidate mobility modules within a predetermined distance of the call location. The mobility service providing method additionally includes determining whether to determine a target mobility module, among the plurality of candidate mobility modules, is eligible for selection as a final mobility module based on determining whether residual electric energy of the target mobility module satisfies a predetermined reference value condition. The mobility service providing method further still includes determining the final mobility module, among the plurality of candidate mobility modules, based on locations of each of the plurality of candidate mobility modules and first residual electric energy of each of the plurality of candidate mobility modules. The mobility service providing method additionally includes determining an estimated charge for the call command based on a result of comparing the required electric energy and the charging electric energy and transmitting a call signal to the final mobility module based on the estimated charge.

Determining the estimated charge may include, based on determining that the charging electric energy is less than or equal to the required electric energy, determining the estimated charge by adding i) a predetermined additional charge rate per unit electric energy multiplied by a value obtained by subtracting the charging electric energy from the required electric energy to ii) a predetermined basic charge.

Determining the estimated charge may include, based on determining that the charging electric energy is greater than the required electric energy, determining an additional charging amount that the place module is to provide to the final mobility module as a smallest value among a value obtained by multiplying a travel time from the call location to the destination by the predetermined charging amount per hour, a value obtained by subtracting the required electric energy from the charging electric energy, and a value obtained by subtracting the residual electric energy of the final mobility module and the required electric energy corresponding to travel from a current location of the final mobility module to the call location from a maximum charging amount of a predetermined mobility module. Determining the estimated charge may include determining that estimated charge by subtracting a value obtained by multiplying the charging amount by a predetermined charging discount charge rate from a predetermined basic charge.

The mobility service providing method may further include: determining, by the processor, a candidate mobility module located closest to the call location among the plurality of candidate mobility modules as the target mobility module; collecting, by the processor, the first residual electric energy of the target mobility module from the target mobility module; determining, by the processor, a first travel distance, a first travel time, and a first required electric energy corresponding to the first travel distance and the first travel time from the current location of the target mobility module to the call location; and based on determining that the first travel distance is less than or equal to a predetermined maximum service distance, determining, by the processor, whether to select the target mobility module as the final mobility module based on determining whether a first value obtained by subtracting the first required electric energy and the electric energy corresponding to the minimum SoC of the predetermined mobility module from the first residual electric energy is less than a second value obtained by subtracting the charging electric energy from the required electric energy.

The mobility service providing method may further based on determining that the first value obtained by subtracting the first required electric energy and the electric energy corresponding to the minimum SoC of the predetermined mobility module from the first residual electric energy is less than the second value obtained by subtracting the charging electric energy from the required electric energy, determining remaining candidate mobility modules, among the plurality of candidate mobility modules, excluding the target mobility module as a plurality of new candidate mobility modules. The mobility service providing method may include determining the mobility module located closest to the call location among the plurality of new candidate mobility modules as a new target mobility module.

The mobility service providing method may further include, based on determining that the first value obtained by subtracting the first required electric energy and the electric energy corresponding to the minimum SoC of the predetermined mobility module from the first residual electric energy is greater than or equal to the second value obtained by subtracting the charging electric energy from the required electric energy, determining the target mobility module as the final mobility module.

The mobility service providing method may further include, based on receiving a response from the user terminal indicating that the power of the place module is used for the travel, determining the charging electric energy by subtracting indoor power consumption of the place module during the travel and a residual target electric energy at the destination from the residual electric energy of the place module.

According to embodiment of the present disclosure, when a customer owning a place module calls a mobility module, the place module and the mobility module may travel in a combined state according to the call.

According to embodiments of the present disclosure, when the mobility module matched with the place module transports the place module, the power charged in the battery of the place module is provided to the battery of the mobility module, thereby minimizing the work required to separately charge the mobility module, such as moving/collecting/delivering/charging, thereby reducing the business gap equivalent to the time required for the work required for charging.

According to embodiments of the present disclosure, unlike the conventional call service that requires payment of a fixed usage fee, the battery of the place module can be freely charged at a desired time, and a fee discount can be received by providing power to the mobility module while moving, so the satisfaction of both the customer owning the place module and the business owner owning multiple mobility modules can be improved.

According to embodiments of the present disclosure, since the electric energy consumed by the mobility module while moving can be reduced, the number of visits to the charging station can be reduced accordingly. Accordingly, it is possible to decrease the electric energy consumed for visiting the charging station.

### BRIEF DESCRIPTION OF THE DRAWINGS

FIG. 1 is a block diagram schematically illustrating a mobility service providing system, according to an embodiment.

FIG. 2 is a block diagram schematically illustrating a control server of a mobility service providing system, according to an embodiment.

FIG. 3 is a flowchart of a mobility service providing method. according to an embodiment.

FIG. 4 is a detailed flowchart of a process for determining charging electric energy in connection with the method illustrated in FIG. 3, according to an embodiment.

FIG. 5 is a detailed flowchart of a process for determining indoor power consumption in connection with the process illustrated in FIG. 4, according to an embodiment.

FIG. 6 is a detailed flowchart of a process for determining residual target electric energy in connection with the process illustrated in FIG. 4, according to an embodiment.

FIG. 7 is a detailed flowchart of a process for determining a final mobility module in connection with the method illustrated in FIG. 3, according to an embodiment.

FIG. 8 is a detailed flowchart of a process for transmitting a call signal to a final mobility module in connection with the method illustrated in FIG. 3, according to an embodiment.

FIG. 9 is a detailed configuration diagram of a user terminal in a mobility service providing system according to another embodiment, according to an embodiment.

FIG. 10 is a diagram schematically illustrating an application installed on a user terminal illustrated in FIG. 9, according to an embodiment.

### DETAILED DESCRIPTION

Hereafter, embodiments of the present disclosure are described in detail with reference to the accompanying drawings. In the following description, the same or similar components are given the same reference numerals and are not repeatedly described. Terms such as “module” and/or “unit” used with components in the following description are used only for ease of explanation, and therefore, do not have meanings or roles that distinguish from each other in themselves. In addition, where it was determined that a detailed description of a known feature or function would obscure the gist of the present disclosure, the detailed description thereof has been omitted. Further, it should be understood that the accompanying drawings are provided only to enhance understanding of embodiments of the present disclosure, and the spirit of the present disclosure is not limited by the accompanying drawings, but includes all the modifications, equivalents, and substitutions included in the spirit and the scope of the present disclosure.

Terms including an ordinal number such as first, second, etc., may be used to describe various components, but the components are not limited to these terms. These terms are used solely for the purpose of distinguishing one component from another.

It should be further understood that terms such as “include,” “comprise,” “have,” etc., and variations thereof, used in the present specification specify the presence of features, numerals, steps, operations, components, parts, etc. mentioned in the present specification, or combinations thereof, but do not preclude the presence or addition of one or more other features, numerals, steps, operations, components, parts, or combinations thereof.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, interface, apparatus, server, and the like may separately embody or be included with a processor and a memory, such as a non-transitory computer readable media, as part of the apparatus.

Among the components according to an embodiment, a program implemented as a set of instructions specifying a control algorithm necessary for controlling other components may be installed in a component that controls other components under specific control conditions. The control component may process input data and stored data according to installed programs to generate output data. The control component may include a non-volatile memory for storing programs and a memory for storing data.

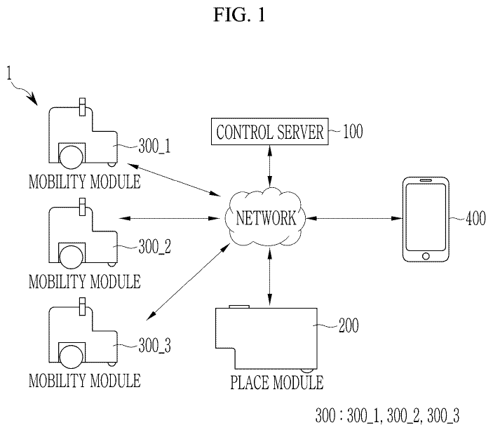

FIG. 1 is a block diagram schematically illustrating a mobility providing system, according to an embodiment.

Referring to FIG. 1, a mobility provision system 1 may include a control server 100, a place module 200, a plurality of mobility modules 300_1 to 300_3, and a user terminal 400. Each of the place module 200, the plurality of mobility modules 300_1 to 300_3, and the user terminal 400 may communicate with the control server 100 through a network.

The network refers to a connection structure that enables information exchange between each node, such as the control server 100, the place module 200, the plurality of mobility modules 300_1 to 300_3, and the user terminal 400. For example, the network may include a local area network (LAN), a wide area network (WAN), the Internet (WWW: World Wide Web), a wired and wireless data communication network, a telephone network, a wired and wireless television communication network, etc. The wireless data communication network includes, but is not limited to, 3G, 4G, 5G, 3rd Generation Partnership Project (3GPP), Long Term Evolution (LTE), World Interoperability for Microwave Access (WIMAX), Wi-Fi, Bluetooth communication, infrared communication, ultrasonic communication, visible light communication (VLC), LiFi, etc.

In FIG. 1, the number of mobility modules is illustrated as three, but this is for convenience of description and the present disclosure is not limited thereto. Generally, in various embodiments, the mobility providing system 1 may include one or more mobility modules. Hereinafter, when describing the common operation and technical features of the plurality of mobility modules 300_1 to 300_3, the plurality of mobility modules 300_1 to 300_3 are collectively referred to as a mobility module 300 (e.g., a mobility device or apparatus, such as a vehicle, including autonomous devices, apparatuses, and vehicles).

The mobility provision system 1 may provide a mobility service (hereinafter referred to as “mobility service”) that matches the mobility module 300 to the place module 200 to transport the place module 200 in response to a call from the user terminal 400. The mobility service may include a service that matches the mobility module 300 to the place module 200 and transports the place module 200 according to a user's request using the mobility module 300.

The user terminal 400 is a communication device that may provide information related to a detachable mobility charging service to a user and may receive information for providing the detachable mobility charging service from the user. For example, the user terminal 400 may be a computer, a tablet PC, a wireless phone, a mobile phone, a smart phone, a smart watch, a smart glass, a portable game console, etc., capable of communication.

The user terminal 400 may provide a screen that displays the residual electric energy of the place module 200 in real time according to the user's settings.

The user terminal 400 may transmit a call command input by the user to the control server 100. The user terminal 400 may provide a screen that may enable a user to input travel information for transporting the place module from the call location to the destination through an application installed on the user terminal 400. The user may thus input the travel information via the user terminal 400. In an embodiment, the travel information may include a destination, identification information of a preferred vehicle, a minimum target state of charge (SOC) value, etc. The identification information of the vehicle may be, for example, model information of the vehicle. The call command that the user terminal 400 transmits to the control server 100 may include the travel information input by the user.

The place module 200 (i.e., an occupant carrier or transporter, such as a trailer) may provide a space that may be used by the user for a specific purpose. The place module 200 may travel while being coupled to (e.g., attached to) the mobility module 300 (such as a trailer attached to a vehicle), and may travel by directly/indirectly receiving power generated by the mobility module 300. Accordingly, the user may use the desired space at any location by using the place module 200. For example, a user may use the place module 200 as a living space or a warehouse, and when travel is required, the user may call (i.e., request) the mobility module 300. The mobility module 300 may then be combined with (e.g., attached or coupled to) the place module 200 to transport the place module 200 to a desired location. According to various embodiments, the place module 200 may have various forms depending on the user's intended use. For example, the place module 200 used as a living space may have lighting, electrical equipment, home appliances, furniture, etc., installed inside.

The place module 200 may include a battery for storing energy used in the place module 200 or the mobility module 300. The place module 200 may estimate the current battery capacity or state of charge (SoC) of the battery mounted on the place module 200 and may transmit the estimated SoC to the control server 100. The capacity of the battery included in the place module 200 may be set in various ways depending on the size and weight of the place module 200. The place module 200 may calculate or otherwise determine a current location using GPS, etc., and may transmit the calculated current location to the user terminal 400 or the control server 100.

It is noted that although terms “calculate” or “calculating” a value, an amount, etc., and variations thereof, may be used in the present disclosure, this is merely for convenience of explanation and the present disclosure is not limited thereto. In some embodiments, the value, the amount, etc. may be determined in other suitable manners.

The mobility module 300 may be used as a means of transportation to provide a transportation service that receives a call command from the user terminal 400 and transports the place module 200 to a specific location (hereinafter, referred to as a “destination”). In an embodiment, the call command is a command to call the mobility module 300 to the current location (hereinafter, referred to as a “call location”) of the place module 200. The call command may include travel information such as a schedule, a usage time, call location, and destination information for which the user wants to travel the place module 200 using the mobility module 300. In an embodiment, the mobility module 300 is a device that may generate power and may travel on its own, and may be combined with (e.g., attached to) the place module 200 to transport the place module 200 to the destination.

The mobility module 300 may be a means of transportation capable of autonomous driving. The types of mobility module 300 may include an economical type, a standard type, and a high-performance type. The mobility module 300 may include a battery for storing energy for the travel of the mobility module 300 and the place module 200. The capacity of the battery included in the mobility module 300 may be set in various ways depending on the type, size, and weight of the mobility module 300. For example, the economical mobility module 300 may be a module equipped with a low output motor and a high capacity battery, the standard mobility module 300 may be a module equipped with a normal output motor and a normal capacity battery, and the high-performance drive module may be a module equipped with a high output motor and a low capacity battery.

The mobility module 300 may estimate the current battery capacity or SoC of the battery of the mobility module 300 and may transmit the estimated SOC to the control server 100.

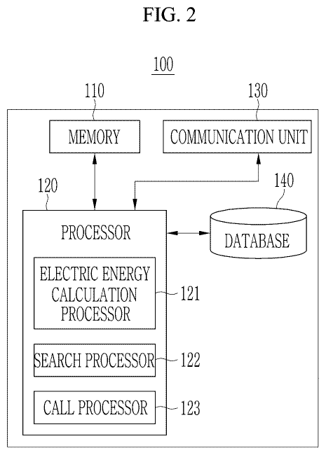

FIG. 2 is a block diagram schematically illustrating a control server of a mobility service providing system, according to one embodiment.

Referring to FIG. 2, the control server 100 may include a memory 110, a processor 120, a communication unit 130, and a database 140.

The memory 110 may store various programs and commands for providing a mobility service according to embodiments of the present disclosure. The program stored in the memory 110 may include a program (hereinafter, “mobility module matching program”) that matches the mobility module 300 in response to the call from the place module 200.

The “processor” may refer to a configuration that processes an operation, a logic operation, a determination operation, etc., to provide at least one function, and this configuration may be implemented by hardware, software, or a combination of hardware and software. For example, the processor may be implemented by software such as a task, a class, a subroutine, a process, an object, an execution thread, a program performed in a predetermined area on a memory, or hardware such as a field-programmable gate array (FPGA) or an application-specific integrated circuit (ASIC), and may also be formed by a combination of the software and hardware. The processor may be included in a computer readable storage medium or may be partially dispersed and distributed in a plurality of computers.

The processor 120 may include an electric energy calculation processor 121, a search processor 122, and a call processor 123. When receiving the call command from the user terminal 400, the processor 120 may execute a mobility module matching program to perform the operations described in more detail below.

The communication unit 130 (also sometimes referred to herein as a “communication interface”) may communicate with the place module 200, the mobility module 300, and the user terminal 400 through the network. The communication unit 130 may receive the call command from the user terminal 400 and may transmit the received call command to the processor 120. The communication unit 130 may communicate with the place module 200 and may receive residual electric energy R of the place module 200. Hereinafter, the communication unit 130 transmitting and receiving data via the network is sometimes described as the control server 100 transmitting and receiving data via the network.

The electric energy calculation processor 121 may calculate a required electric energy A for travel from the call location to the destination based on the call command The electric energy calculation processor 121 may also calculate charging electric energy K to be provided by the place module 200 to the mobility module 300.

The electric energy calculation processor 121 may collect traffic information from an external server, and may search for, or otherwise determine, a travel route for travel from the call location to the destination based on the collected traffic information. The travel route for travel from the call location to the destination may include a travel distance and a travel time according to the travel route from the call location to the destination. Although the electric energy calculation processor 121 is generally described herein as searching for the travel route for travel from the call location to the destination, the present disclosure is not limited thereto. For example, an external device such as a navigation application that may be installed or otherwise provided in the user terminal 400 may search for the travel route for travel from the call location to the destination, and the electric energy calculation processor 121 may receive a signal indicating the travel route from the external device.

In an embodiment, the required electric energy A may be electric energy corresponding to the travel distance and travel time from the call location to the destination that is calculated by the electric energy calculation processor 121. For example, the electric energy calculation processor 121 may calculate the required electric energy A by multiplying the electric efficiency of the predetermined mobility module 300 by the travel distance from the call location to the destination. However, the method by which the electric energy calculation processor 121 calculates the required electric energy A is not limited thereto. In various embodiments, the required electric energy A may be calculated according to various electric energy prediction methods. The charging electric energy K may be electric energy that may be provided from the place module 200 to the mobility module 300.

The search processor 122 may search for, or otherwise determine, a plurality of candidate mobility modules within a predetermined distance of the call location. The predetermined distance may vary depending on the number of searched candidate mobility modules. For example, when the search processor 122 searches within a range of 1 km based on the call location and the mobility module is not found, the search processor 122 may search again within a range of 2 km based on the call location for the mobility module.

The call processor 123 may determine a target mobility module as one of the plurality of candidate mobility modules. The call processor 123 may determine whether to determine the target mobility module as a final mobility module based on whether the residual electric energy of the target mobility module satisfies a predetermined reference value condition (e.g., the residual electric energy of the target mobility module is equal to or higher than a predetermined reference value). The call processor 123 may calculate the estimated charge for the mobility service based on the required electric energy. As used herein, the estimated charge may be an expected fee for using the final mobility module according to the mobility service. The call processor 123 may calculate the estimated charge for the mobility service based on the required electric energy A calculated from the electric energy calculation processor 121, may generate a call signal for the final mobility module, and may transmit the generated call signal to the final mobility module. The call signal generated by the call processor 123 may include the call location.

The database 140 may store information associated with each of the place module 200, the mobility module 300, and the user terminal 400. The database 140 may include vehicle model information corresponding to the identification information of the preferred vehicle among the travel information received from the user terminal 400. The vehicle model information may include weight, aerodynamics, tire specifications, motor information, reduction ratio, maximum speed, etc., of a vehicle.

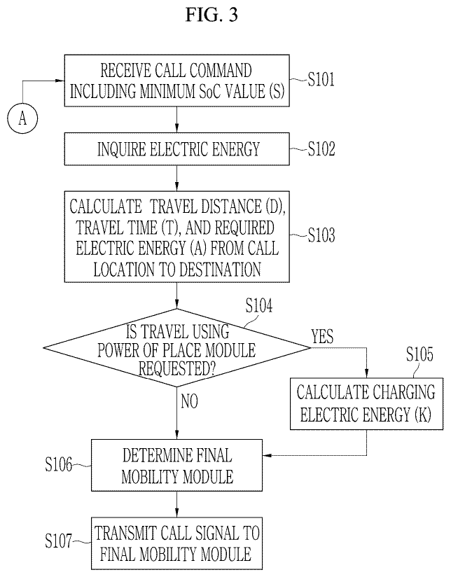

Hereinafter, the operations of the control server 100, the place module 200, the mobility module 300, and the user terminal 400, according to embodiments of the present disclosure, are described in more detail with reference to FIGS. 3-8.

FIG. 3 is a flowchart of a mobility service providing method, according to an embodiment.

Hereinafter, descriptions of the control server 100, the place module 200, the mobility module 300, and the user terminal 400 that overlap with the above description may be omitted.

Referring to FIG. 3, in an operation S101, the communication unit 130 may receive the call command from the user terminal 400. The call command may include a minimum target SoC value S of the user.

In an operation S102, the communication unit 130 may communicate with the place module 200 and may request and obtain the residual electric energy R of the place module 200.

When receiving the call command from the user terminal 400, the electric energy calculation processor 121 may search for the travel route from the call location to the destination based on the call command. In an operation S103, the electric energy calculation processor 121 may calculate a travel distance D and a travel time T from the call location to the destination, and may calculate the required electric energy A corresponding to the travel distance D and the travel time T. In an embodiment, a unit of the travel distance D may be km. In an embodiment, a unit of the travel time T may be hour.

In an operation S104, the communication unit 130 may inquire whether the user terminal 400 requests travel using the power of the place module 200. For example, the communication unit 130 may transmit an inquiry to the user terminal 400 saying, “Do you want to travel inexpensively using the power of the place module 200?”. The user terminal 400 may provide a screen for inquiring whether to travel using the power of the place module 200. When a user inputs a response to a question through the user terminal 400, an application installed in the user terminal 400 may transmit the input response to the control server 100 through the user terminal 400. The communication unit 130 may receive the response from the user terminal 400.

When the response received by the communication unit 130 from the user terminal 400 is a response indicating that the place module 200 travels using its power (Yes in the operation S104), the electric energy calculation processor 121 may calculate the charging electric energy K in an operation S105. The charging electric energy K may be electric energy that may be provided from the place module 200 to the mobility module 300.

In an operation S106, when the charging electric energy K is calculated in the operation S105 or when the response received by the communication unit 130 from the user terminal 400 is a response that the place module 200 travels without using its power (NO in the operation S104), the call processor 123 may determine the final mobility module. In an embodiment, when the response received by the communication unit 130 from the user terminal 400 in the operation S104 is the response that the place module 200 travels without using its power (NO in the operation S104), the final mobility module should be determined without calculating the charging electric energy K. In an embodiment, when the response received by the communication unit 130 from the user terminal 400 in the operation S104 is the response that the place module 200 travels without using its power (NO in the operation S104), the electric energy calculation processor 121 may calculate the charging electric energy K as 0.

When the response received by the communication unit 130 from the user terminal 400 in the operation S104 is the response that the place module 200 travels without using power (NO in the operation S104) and the operation S106 is performed, the call processor 123 may determine the final mobility module based on the required electric energy A. When the operation S106 is performed following the operation S105, the call processor 123 may compare the required electric energy A with the charging electric energy K and may determine the final mobility module based on the result of the comparison.

In an operation S107, the call processor 123 may transmit the call signal to the final mobility module.

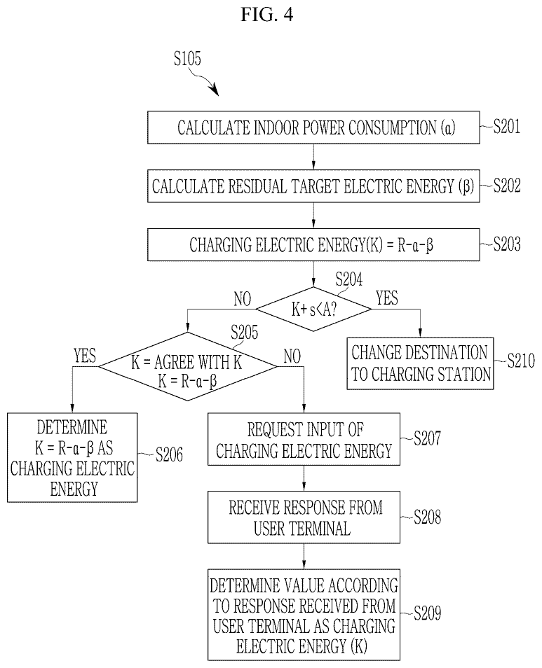

FIG. 4 is a detailed flowchart of step S105 illustrated in FIG. 3, according to an embodiment.

Referring to FIG. 4, in an operation S201, the electric energy calculation processor 121 may calculate indoor power consumption α of the place module 200 while the place module is traveling. The indoor power consumption α may be electric energy according to the indoor power mode of the place module 200. The place module 200 may be equipped with internal devices (hereinafter referred to as “internal devices”) such as lighting, electrical equipment, and home appliances.

The electric energy calculation processor 121 may determine an indoor power mode of the place module 200 as one of a low-power mode, an intermediate mode, and a high-power mode according to the power consumption of the internal devices while the place module 200 is traveling from the call location to the destination.

The low-power mode may be a state that minimizes the power consumption of the internal devices. For example, the low-power mode may be a relax mode for a user to rest, sleep, etc. inside the place module 200.

The intermediate mode may be a state that increases the power consumption of internal device to a certain degree compared to the low-power mode. For example, the intermediate mode may be a work mode for a user to work, read, cook, etc., inside the place module 200.

The high-power mode may be a state that maximizes the power consumption of internal devices. For example, the high-power mode may be an entertain mode for a user to play games, sing karaoke, have a party, etc., inside the place module 200.

In an operation S202, the electric energy calculation processor 121 may determine the driving mode based on the information received from the user terminal 400 by the communication unit 130, and may calculate residual target electric energy β after the travel of the place module 200. The residual target electric energy β may be a reference for the electric energy required to remain in the battery of the place module 200 when the user arrives at the destination.

The driving mode may be one of a one-way mode, a round-trip mode, or a stay mode. The one-way mode may be a mode for traveling from the call location to the destination. The round-trip mode may be a mode for returning from the call location to the call location through the destination. The stay mode may be a mode for traveling from the call location to the destination, staying at the destination for the stay time, and returning from the destination to the call location. Hereinafter, the call location that returns after passing through/staying at the destination in each of the round-trip mode and the stay mode is referred to as the “final arrival location.”

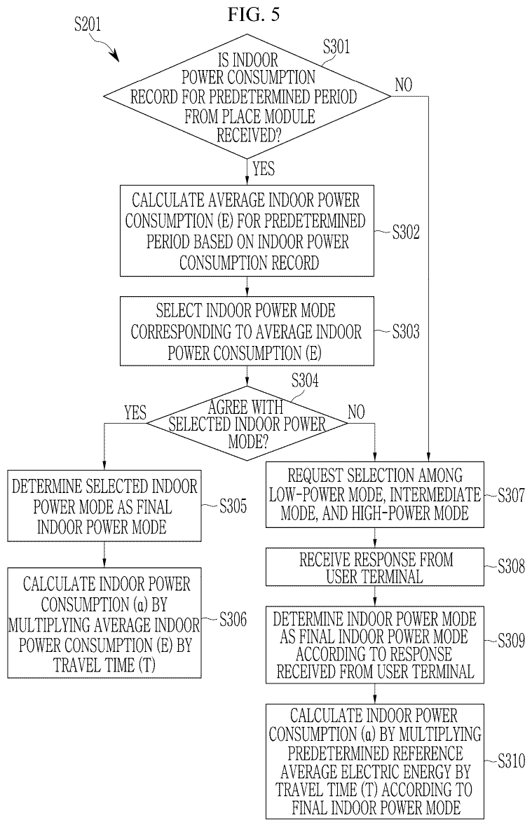

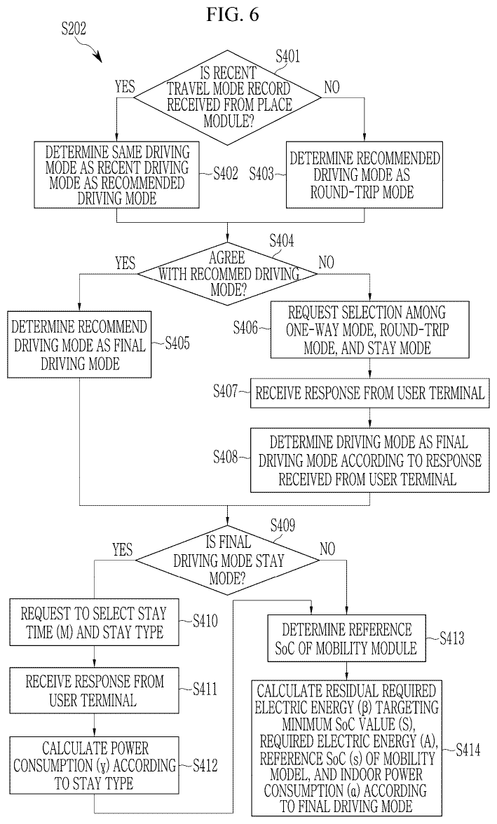

Hereinafter, steps S201 and S202 illustrated in FIG. 4, according to an embodiment, are described in more detail with reference to FIGS. 5 and 6, respectively.

FIG. 5 is a detailed flowchart of step S201 illustrated in FIG. 4, according to an embodiment.

Referring to FIG. 5, in an operation S301, the communication unit 130 may determine whether an indoor power consumption record for a recent predetermined period is received from the place module 200. The predetermined period may be determined in advance as an initial meeting. For example, the predetermined period may be one month.

When it is determined in the operation S301 that the indoor power consumption record is received (Yes in the operation S301), the electric energy calculation processor 121 may, in an operation S302, calculate an average indoor power consumption E for the predetermined period based on the indoor power consumption record for the predetermined period. The average indoor power consumption E calculated in the operation S302 may be, for example, the monthly average indoor power consumption.

In an operation S303, the electric energy calculation processor 121 may select the indoor power mode corresponding to the calculated average indoor power consumption E. For example, when the average indoor power consumption E is 1 kW or less, the electric energy calculation processor 121 may select the indoor power mode as the low-power mode. When the average indoor power consumption E exceeds 1 kW and is 2 kW or less, the electric energy calculation processor 121 may select the indoor power mode as the intermediate mode. When the average indoor power consumption E exceeds 2 kW, the electric energy calculation processor 121 may select the indoor power mode as the high-power mode.

The electric energy calculation processor 121 may determine the indoor power mode based on whether the user agrees with the indoor power mode selected in response to the average indoor power consumption E. In an operation S304, the communication unit 130 may inquire the user terminal 400 whether to agree with the indoor power mode selected by the electric energy calculation processor 121 in the operation S303. For example, the communication unit 130 may transmit an inquiry to the user terminal 400 such as “The average indoor power consumption is 1.5 kW. Do you want to change the indoor power mode to work mode?”

The user terminal 400 may provide a screen for inquiring whether to agree with the indoor power mode selected from the electric energy calculation processor 121. When the user inputs a response to a question through the user terminal 400, the application installed in the user terminal 400 may transmit the input response to the control server 100 through the user terminal 400. The communication unit 130 may receive the response from the user terminal 400.

When the response received by the communication unit 130 from the user terminal 400 in the operation S304 is a response agreeing to the selected indoor power mode (Yes in the operation S304), the electric energy calculation processor 121 may determine the selected indoor power mode as the final indoor power mode in an operation S305.

In an operation S306, the electric energy calculation processor 121 may calculate the indoor power consumption α by multiplying the average indoor power consumption E calculated in the operation S302 by the travel time T.

When the indoor power consumption record is not received in the operation S301 (No in the operation S301) or when the response received by the communication unit 130 from the user terminal 400 in the operation S304 is a response that does not agree with the selected indoor power mode (No in the operation S304), the communication unit 130 may, in an operation S307, request the user terminal 400 to select an indoor power mode among the low-power mode, the intermediate mode, and the high-power mode. The user terminal 400 may provide a screen for selecting the indoor power mode among the low-power mode, the intermediate mode, and the high-power mode.

When the user selects and inputs one of the low-power mode, the intermediate mode, or the high-power mode through the user terminal 400, the application installed in the user terminal 400 may transmit the input response to the control server 100 through the user terminal 400. The communication unit 130 may receive the response from the user terminal 400 in an operation S308.

In an operation S309, the electric energy calculation processor 121 may determine the indoor power mode according to the response received from the user terminal 400 in the operation S308 as the final indoor power mode.

In an operation S310, the electric energy calculation processor 121 may multiply a predetermined reference average electric energy according to the determined final indoor power mode by the travel time T to calculate the indoor power consumption α.

The predetermined reference average electric energy may be stored in the database 140 as initial information in advance according to the indoor power mode being the low-power mode, the intermediate mode, and the high-power mode, respectively. The predetermined reference average electric energy may be electric energy in a range corresponding to the average indoor power consumption E calculated in the operation S302. In an embodiment, the reference average electric energy in the case where the indoor power mode is the low-power mode is less than the reference average electric energy in the case where the indoor power mode is the intermediate mode. In an embodiment, the reference average electric energy in the case where the indoor power mode is the intermediate mode is less than the reference average electric energy in the case where the indoor power mode is the high-power mode. For example, the reference average electric energy may be a monthly average of 1 kW in the low-power mode, a monthly average of 2 kW in the intermediate mode, and a monthly average of 3 kW in the high-power mode.

FIG. 6 is a detailed flowchart of step S202 illustrated in FIG. 4, according to an embodiment.

Referring to FIG. 6, in an operation S401, the communication unit 130 may receive a recent driving mode record from the place module 200.

When the recent driving mode record is received in the operation S401 (Yes in the operation S401), the electric energy calculation processor 121 may, in an operation S402, determine the same driving mode as the recent driving mode record as the recommended driving mode.

When the recent driving mode record is not received in the operation S401 (No in the operation S401), the electric energy calculation processor 121 may, in an operation 403, determine the recommended driving mode as one of the driving modes. For example, the electric energy calculation processor 121 may, in the operation S403, determine the recommended driving mode as the round-trip mode.

In an operation S404, the communication unit 130 may inquire the user terminal 400 whether to agree with the recommended driving mode. For example, the communication unit 130 may transmit an inquiry to the user terminal 400 such as “The recommended/recent driving mode is round-trip mode. Do you want to proceed as it is?”

The user terminal 400 may provide a screen for inquiring whether to agree with the recommended driving mode. When the user inputs a response to a question through the user terminal 400, the application installed in the user terminal 400 may transmit the input response to the control server 100 through the user terminal 400. The communication unit 130 may receive the response from the user terminal 400.

When the response received by the communication unit 130 from the user terminal 400 in the operation S404 is a response agreeing to the selected recommended driving mode (Yes in the operation S404), the electric energy calculation processor 121 may, in an operation S405, determine the recommended driving mode as the final driving mode.

When the response received by the communication unit 130 from the user terminal 400 in the operation S404 is a response that does not agree with the selected recommended driving mode (No in the operation S404), the communication unit 130 may, in an operation 406, request the user terminal 400 to select the driving mode among the one-way mode, the round-trip mode, and the stay mode. The user terminal 400 may provide a screen for selecting the driving mode among the one-way mode, the round-trip mode, and the stay mode.

When the user selects and inputs one of the one-way mode, the round-trip mode, and the stay mode through the user terminal 400 in step S406, the application installed in the user terminal 400 may transmit the input response to the control server 100 through the user terminal 400. The communication unit 130 may receive the response from the user terminal 400 in an operation S407.

In an operation S408, the electric energy calculation processor 121 may determine the driving mode according to the response received from the user terminal 400 in the operation S407 as the final driving mode.

In an operation S409, the electric energy calculation processor 121 may determine whether the final driving mode is the stay mode.

When the final driving mode is the stay mode in the operation S409 (Yes in the operation S409), the communication unit 130 may, in an operation S410, request the user terminal 400 to select a stay time M and the stay type. For example, the communication unit 130 may transmit an inquiry of “How many hours is the stay time?” and “What is the stay type?” to the user terminal 400. The user terminal 400 may provide a screen for selecting the stay time M and the stay type. The selection of the stay type may be selecting one of the low-power mode, the intermediate mode, or the high-power mode corresponding to the indoor power mode described above.

When the user inputs the stay time M through the user terminal 400 and selects and inputs the stay type as one of the low-power mode, the intermediate mode, and the high-power mode, the application installed in the user terminal 400 may transmit the input response to the control server 100 through the user terminal 400. The communication unit 130 may receive the response from the user terminal 400 in an operation S411).

In an operation 412, the electric energy calculation processor 121 may calculate power consumption γ during the stay by multiplying the stay time M according to the response received from the user terminal 400 in the operation S411 by the predetermined reference average electric energy according to the response of the stay type. The reference average electric energy when the stay type is the low-power mode may be less than the reference average electric energy when the stay type is the intermediate mode, and the reference average electric energy when the stay type is the intermediate mode may be less than the reference average electric energy when the stay type is the high-power mode. For example, the predetermined reference average electric energy may be a monthly average of 1 kW in the low-power mode, a monthly average of 2 kW in the intermediate mode, and a monthly average of 3 kW in the high-power mode. Since the stay mode is for the stay time M at the destination, the power consumption γ during the stay may vary depending on the stay mode.

When the final driving mode is not the stay mode in the operation S409 (NO in the operation S409), or when the power consumption is calculated in the operation S412, the power calculation processor 121 may, in an operation S413, determine a reference SoC(s) of the mobility module 300.

When there is a SoC record at the time of connection of the mobility module 300 in the database 140, the electric energy calculation processor 121 may calculate an average SoC of the SoC record and determine the calculated average SoC as the reference SoC(s) of the mobility module 300. The SoC record at the time of connection of the mobility module 300 may include the SoC of the battery of the coupled mobility module (e.g., 300_1) at each time point(s) when the place module 200 is coupled to one of the plurality of mobility modules 300_1 to 300_3.

When there is no SoC record at the time of connection of the mobility module 300 in the database 140, the electric energy calculation processor 121 may determine a predetermined SoC value as the reference SoC(s). For example, the predetermined SoC value may be 80% of the power value corresponding to the maximum SoC of the mobility module 300.

In an operation S414, the electric energy calculation processor 121 may calculate the residual target electric energy β based on the minimum target SoC value S included in the call command, the required electric energy A, the reference SoC(s) of the mobility module 300, and the indoor power consumption α according to the final driving mode.

When the final driving mode is the one-way mode, the electric energy calculation processor 121 may determine the residual target electric energy β as the power value β=S corresponding to the minimum target SoC value S. Since the destination is a final arrival location in the one-way mode, the residual target electric energy β at the destination in the one-way mode is the power value corresponding to the minimum target SoC value S input by the user.

The round-trip mode uses the destination as a transit point, and the electric energy is required to return from the destination to the final arrival location which is the final arrival location. Therefore, the minimum target SoC value S in the round-trip mode may be the value obtained by subtracting the indoor power consumption α and required electric energy A corresponding to the one-way travel from the destination to the starting point from the sum of the residual target electric energy β at the destination and the power value corresponding to the reference SoC(s) of the mobility module 300. Therefore, when the final driving mode is the round-trip mode, the electric energy calculation processor 121 may determine the residual target electric energy β as a value β=α+A+S−s obtained by subtracting the power value corresponding to the reference SoC(s) of the mobility module 300 from the sum of the power values corresponding to the indoor power consumption α, the required electric energy A, and the minimum target SoC value S.

The stay mode uses the destination as the transit point, and the electric energy to stay at the destination and electric energy to return from the destination to the final arrival location, which is the final arrival location, are required. Therefore, the minimum target SoC value S in the stay mode may be a value obtained by subtracting the indoor power consumption α, the required electric energy A, and the power consumption γ during the stay corresponding to the one-way travel from the destination to the starting point from the sum of the residual target electric energy β at the destination and the power value corresponding to the reference SoC(s) of the mobility module 300. Therefore, when the final driving mode is the stay mode, the electric energy calculation processor 121 may determine the residual target electric energy β as a value β=γ+α+A+S−s obtained by subtracting the power value corresponding to the reference SoC(s) from the sum of the power consumption γ during the stay, the indoor power consumption α, the required electric energy A, and the power value corresponding to the minimum target SoC value S.

Referring back to FIG. 4, following in an operation S203, the electric energy calculation processor 121 may calculate a value obtained by subtracting the indoor power consumption α and the residual target electric energy β from the residual electric energy R of the place module 200 as the charging electric energy K (K=R−α−β).

When the sum of the electric energy to be provided by the place module 200 to the mobility module 300 and the electric energy already charged in the mobility module 300 is less than the required electric energy, it is difficult for the place module 200 and the mobility module 300 to arrive at the destination or final arrival location without separate charging. In an operation S204, the electric energy calculation processor 121 may determine whether the sum of the charging electric energy K calculated in the operation S203 and the power value corresponding to the reference SoC(s) is less than the required electric energy A.

When the sum of the charging electric energy K and the power value corresponding to the reference SoC(s) is greater than or equal to the required electric energy A (No in the operation S204), the communication unit 130 may, in an operation S205, inquire the user terminal 400 whether to agree with the charging electric energy K=R−α−β calculated in the operation S203. For example, the communication unit 130 may transmit an inquiry to the user terminal 400 such as, “When you use up to [K] kWh of energy from your module, you may call the cheapest service. Do you want to proceed as it is?”

The user terminal 400 may provide a screen inquiring whether to agree with the calculated charging electric energy K. When the user inputs a response to a question through the user terminal 400, the application installed in the user terminal 400 may transmit the input response to the control server 100 through the user terminal 400. The communication unit 130 may receive the response from the user terminal 400.

When the response received by the communication unit 130 from the user terminal 400 in the operation S205 is a response that agrees with the charging electric energy K=R−α−β calculated in the operation S203 (Yes in the operation S205), the electric energy calculation processor 121 may, in an operation S206, determine the calculated charging electric energy K=R−α−β as the final charging electric energy K.

When the response received by the communication unit 130 from the user terminal 400 in step S205 is a response that does not agree with the charging electric energy K=R−α−β calculated in the operation S203 (No in the operation S205), the communication unit 130 may, in an operation S207, request the user terminal 400 to input the charging electric energy within the range of R−α−β. The user terminal 400 may provide a screen for inputting the charging electric energy. The minimum value of the charging electric energy that the user may input may be the larger value max[0, A−s] of the value obtained by subtracting the power value corresponding to the reference SoC(s) from the required electric energy A and 0. The maximum value of the charging electric energy that the user may input may be R−α−β.

When the user inputs the charging electric energy through the user terminal 400, the application installed in the user terminal 400 may transmit the input response to the control server 100 through the user terminal 400. The communication unit 130 may receive the response from the user terminal 400 in an operation S208.

In an operation S209, the electric energy calculation processor 121 may determine the charging electric energy according to the response received from the user terminal 400 in step S208 as the final charging electric energy K.

The charging electric energy K may represent the final charging electric energy determined in the operation S206 or the final charging electric energy determined in the operation S209.

When the sum of the charging electric energy K and the power value corresponding to the reference SoC(s) in the operation S204 is less than the required electric energy A (No in the operation S204), the call processor 123 may, in an operation S210, change the destination to the charging station.

For example, the communication unit 130 may inquire of the user terminal 400 whether to travel to the electric charging station (hereinafter, “nearby charging station”) located within a predetermined range based on the call location. In an example, the communication unit 130 may transmit an inquiry to the user terminal 400 of “A−s−K kWh is insufficient to reach the destination. Would you like to travel to a nearby charging station?”

The user terminal 400 may provide a screen for inquiring whether to travel to a nearby charging station. When the user inputs a response to a question through the user terminal 400, the application installed in the user terminal 400 may transmit the input response to the control server 100 through the user terminal 400.

The communication unit 130 may receive the response from the user terminal 400. When the response received by the communication unit 130 from the user terminal 400 is a response that does not agree with traveling to the nearby charging station, the communication unit 130 may return to the operation S101 of FIG. 3 and may receive a new call command from the user terminal 400.

When the response received by the communication unit 130 from the user terminal 400 is a response that agrees with traveling to a nearby charging station, the call processor 123 may search for charging stations located within a predetermined range based on the call location. Although the call processor 123 is generally described herein as searching for the charging stations located within the predetermined range based on the call location, the present disclosure is not limited thereto. For example, in some embodiments, the call processor 123 may search for charging stations located within a predetermined distance from any point on the travel route from the call location to the destination.

The communication unit 130 may transmit a signal indicating the charging stations searched by the call processor 123 to the user terminal 400. The user terminal 400 may provide a screen for selecting one of the charging stations received from the control server 100. When the user selects and inputs one of the nearby charging stations through the user terminal 400, the application installed in the user terminal 400 may transmit the input response to the control server 100 through the user terminal 400. The communication unit 130 may receive the response from the user terminal 400. The call processor 123 may change the charging station according to the response received from the user terminal 400 to a new destination.

After the operation S206 or the operation S209 of FIG. 4, the operation S106 of FIG. 3 may be performed, and after the operation S210 of FIG. 4, the operation S102 of FIG. 3 may be performed.

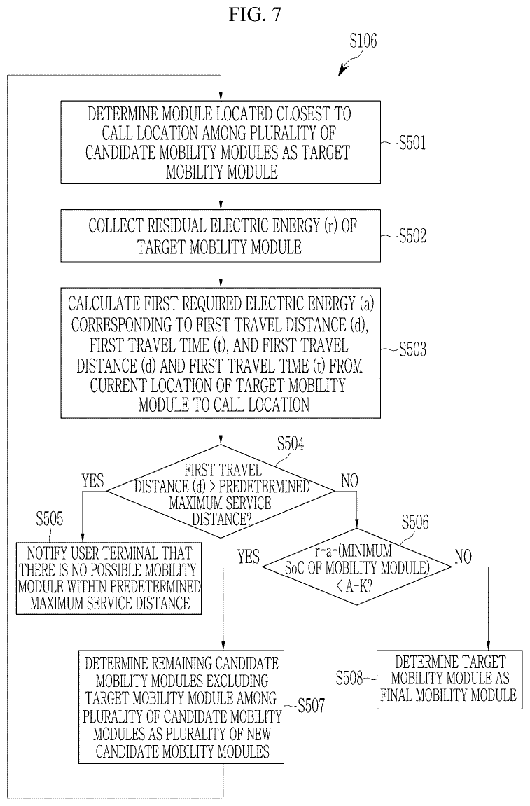

Referring back to FIG. 3, in the operation S106, the call processor 123 may determine the final mobility module. Hereinafter, the operation S106 illustrated in FIG. 3, according to an embodiment, is described in more detail with reference to FIG. 7.

FIG. 7 is a detailed flowchart of step S106 illustrated in FIG. 3, according to an embodiment.

The search processor 122 may search for the plurality of candidate mobility modules within a predetermined distance based on the call location, which is the current location of the place module. Hereinafter, for convenience of description, the plurality of mobility modules 300_1 to 300_3 illustrated in FIG. 1 are assumed to be a plurality of candidate mobility modules according to an embodiment.

Referring to FIG. 7, in an operation S501, the call processor 123 may determine the candidate mobility module (e.g., 300_1) located closest to the call location among the plurality of candidate mobility modules 300_1 to 300_3 as the target mobility module. For convenience of description below, the module located closest to the call location among the plurality of candidate mobility modules 300_1 to 300_3 is set as the mobility module 300_1 illustrated in FIG. 1.

In an operation S502, the call processor 123 may collect a residual electric energy r of the target mobility module 300_1. At the request of the call processor 123, the communication unit 130 may transmit a signal inquiring about the residual electric energy r to the target mobility module 300_1. The communication unit 130 may receive the signal indicating the residual electric energy r from the target mobility module 300_1 in response to the inquiry.

In an operation S503, the call processor 123 may calculate a first travel distance d from the current location of the target mobility module 300_1 to the call location, a first travel time t, and first required electric energy a corresponding to the first travel distance d and the first travel time t. In an embodiment, the unit of the first travel distance d may be km. In an embodiment, the unit of the first travel time t may be hour.

In an operation S504, the call processor 123 may determine whether the first travel distance d exceeds a predetermined maximum service distance. The predetermined maximum service distance may be determined in advance as initial information. For example, the predetermined maximum service distance may be 3 km.

When the first travel distance d exceeds the predetermined maximum service distance (Yes in the operation S504), the communication unit 130 may, in an operation S505, perform a notification operation to notify the user terminal 400 that there is no mobility module available within the predetermined maximum service distance.

On the other hand, when the first travel distance d is less than or equal to the predetermined maximum service distance (No in the operation S504), the call processor 123 may, in an operation S506, determine whether the value obtained by subtracting the first required electric energy a and the electric energy corresponding to the minimum SoC of the predetermined mobility module from the residual electric energy r of the target mobility module 300_1 is less than the value obtained by subtracting the charging electric energy K from the required electric energy A (r-a-minimum SoC of the mobility module<A−K). The minimum SoC of the predetermined mobility module may be a value determined in advance as the minimum reference value of the SoC of the battery of the mobility module 300.

When the value obtained by subtracting the first required electric energy a and the electric energy corresponding to the minimum SoC of the predetermined mobility module from the residual electric energy r of the target mobility module 300_1 is less than the value obtained by subtracting the charging electric energy K from the required electric energy A (r-a-minimum SoC of the mobility module<A−K) in step (Yes in the operation S506), the call processor 123 may, in an operation S507, determine the remaining candidate mobility modules 300_2 and 300_3 excluding the target mobility module 300_1 among the plurality of candidate mobility modules 300_1 to 300_3 determined by the search processor 122 as the plurality of new candidate mobility modules. In an embodiment, the value obtained by subtracting the first required electric energy a and the electric energy corresponding to the minimum SoC of the predetermined mobility module from the residual electric energy r is less than the value obtained by subtracting the charging electric energy K from the required electric energy A (r-a-minimum SoC of the mobility module<A−K), which may be the case where the residual electric energy of the target mobility module 300_1 described above is less than a predetermined reference value. The call processor 123 may transmit the signal indicating that the target mobility module 300_1 is excluded from the plurality of candidate mobility modules to the search processor 122.

Following operation S507, the call processor 123 may perform the operation S501 based on the plurality of new candidate mobility modules 300_2 and 300_3. For example, the call processor 123 may determine the module (e.g., 300_2) located closest to the call location among the plurality of new candidate mobility modules 300_2 and 300_3 as the new target mobility module.

Referring back to the operation S506, when the value obtained by subtracting the first required electric energy a and the electric energy corresponding to the minimum SoC of the predetermined mobility module from the residual electric energy r of the target mobility module 300_1 is greater than or equal to the value obtained by subtracting the charging electric energy K from the required electric energy A (r-a-minimum SoC of the mobility module≥A−K) (No in the operation S506), the call processor 123 may, in an operation S508, determine the target mobility module as the final mobility module. In an embodiment, the value obtained by subtracting the first required electric energy a from the residual electric energy r and the electric energy corresponding to the minimum SoC of the predetermined mobility module is greater than or equal to the value obtained by subtracting the charging electric energy K from the required electric energy A (r-a-minimum SoC of the mobility module≥A−K), which may be the case where the residual electric energy of the target mobility module 300_1 described above is greater than or equal to the predetermined reference value. The final mobility module determined in the operation S508 may be the final mobility module in step S106 of FIG. 3. The call processor 123 may match the determined final mobility module to the place module 200. Hereinafter, for the convenience of description, the final mobility module is described as the mobility module 300_1.

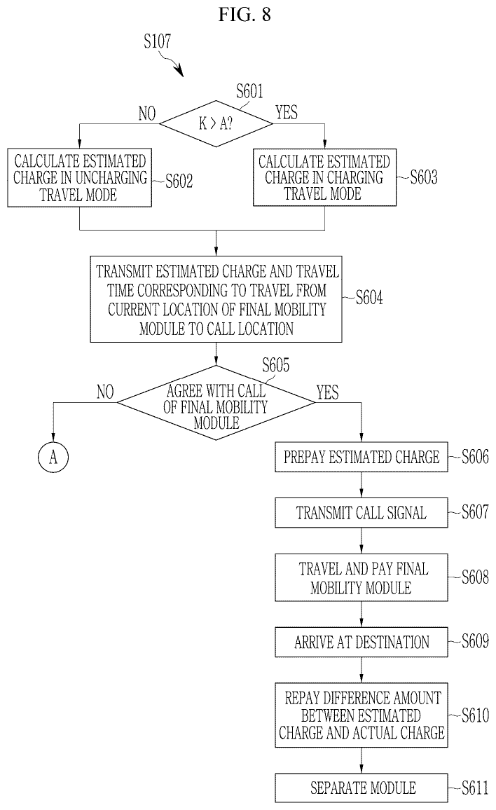

Referring again to FIG. 3, in the operation S107, the call processor 123 may transmit the call signal to the final mobility module 300_1. Hereinafter, the operation S107 illustrated in FIG. 3, according to an embodiment, is described in more detail with reference to FIG. 8.

FIG. 8 is a detailed flowchart of step S107 illustrated in FIG. 3, according to an embodiment.

When the call processor 123 determines the final mobility module 300_1, the call processor 123 calculates the estimated charge for using the final mobility module 300_1, notifies the user of the calculated charge, and then determines a call to the final mobility module 300_1. The call processor 123 may calculate the estimated charge based on the difference between the charging electric energy K and the required electric energy A.

Referring to FIG. 8, in an operation S601, the call processor 123 may determine whether the charging electric energy K is greater than the required electric energy A. When the charging electric energy K is equal to the required electric energy A, the estimated charge may be a predetermined basic charge. The call processor 123 may calculate the basic charge as a value obtained by multiplying the distance used for the mobility service by the unit rate per predetermined unit electric energy. The distance using the mobility service in the one-way mode is the travel distance D from the call location to the destination, and the distance using the mobility service in the round-trip mode or the stay mode may be a sum 2D of the travel distance D from the call location to the destination and the travel distance D from the destination to the call location. A predetermined unit of electric energy may be, for example, 1 kWh. Although the call processor 123 is generally described herein as calculating the basic charge by multiplying the unit rate per unit electric energy by the distance using the mobility service, this is for the convenience of description and the present disclosure is not limited thereto. For example, in some embodiments, the call processor 123 may determine a predetermined amount set as initial information as the basic charge.

When the charging electric energy K is less than or equal to the required electric energy A in the operation S601 (NO in the operation S601), the call processor 123 may, in an operation, calculate the estimated charge in a mode (hereinafter referred to as “uncharging travel mode”) in which the additional charging of the final mobility module 300_1 is not performed with the surplus electric energy remaining in the place module 200 after travel using the mobility service. The uncharging travel mode may be a state in which there is no surplus electric energy remaining in the place module 200 after travel using the mobility service. In the uncharging travel mode, the user terminal 400 may not perform additional charging of the final mobility module 300_1, and therefore may not receive a discount on the rate according to the additional charging.

The call processor 123 may calculate the estimated charge of the uncharging travel mode as the amount (basic charge+predetermined additional charge rate per unit electric energy [KRW/kWh]*A−K) obtained by multiplying a value obtained by adding the basic charge to the predetermined additional charge per unit electric energy by the value obtained by subtracting the charging electric energy K from the required electric energy A. The predetermined additional charge rate per unit electric energy is a rate charged in response to the electric energy remaining after subtracting the charging electric energy K provided by the place module 200 from the required electric energy A, and may be determined in advance as the initial information.

When the charging electric energy K is greater than the required electric energy A in the operation S601 (Yes in the operation S601), the call processor 123 may, in an operation S603, calculate the estimated charge in the mode (hereinafter, “charging travel mode”) in which the additional charging of the final mobility module 300_1 is performed with the surplus electric energy remaining in the place module 200 after the travel using the mobility service. The charging travel mode may be a state in which there is the surplus electric energy remaining in the place module 200 after travel using the mobility service. In the charging travel mode, the user terminal 400 may perform the additional charging of the final mobility module 300_1 using the surplus electric energy and receive a rate discount.

The call processor 123 may calculate an additional charging amount C to be provided by the place module 200 to the final mobility module 300_1 based on a surplus electric energy value obtained by subtracting the required electric energy A from the charging electric energy K. The additional charging amount C is electric energy that may be additionally charged to the final mobility module 300_1 in addition to the electric energy provided by the place module 200 to the final mobility module 300_1 during the use of the mobility service. The call processor 123 may calculate the charging amount C as the smallest value C=min[(predetermined charging amount per hour)*T, K−A, (predetermined maximum charging amount of mobility module)−r−a] among a value obtained by multiplying the travel time T from the call location to the destination by the predetermined charging amount per hour, a value obtained by subtracting the required electric energy A from the charging electric energy K, and a value obtained by subtracting the residual electric energy r of the final mobility module 300_1 and the first required electric energy corresponding to the travel from the current location of the final mobility module 300_1 to the call location from the predetermined maximum charging amount of the mobility module 300. The predetermined charging amount per hour may be the electric energy that may be charged per unit time when charging power from the battery of the place module 200 to the battery of the final mobility module 300_1. The predetermined maximum charging amount of the mobility module 300 is the maximum electric energy that may be charged to the battery of the mobility module 300, and may be determined in advance as initial information.

The call processor 123 may calculate the estimated charge of the charging travel mode as the amount (basic charge−charging discount rate per predetermined unit electric energy [won/kWh]*charging amount C [kWh]) obtained by subtracting the value obtained by multiplying the charging discount rate per predetermined unit electric energy by the additional charging amount C from the basic charge. The charging discount rate per predetermined unit electric energy is a rate discounted from the basic charge by providing more charging electric energy K than the required electric energy A, and may be determined in advance as initial information.

In an operation S604, the communication unit 130 may transmit to the user terminal 400 the estimated charge calculated by the call processor 123 and the first travel time t corresponding to the travel from the current location of the final mobility module 300_1 to the call location. In an operation S605, the call processor 123 may inquire whether to agree with the call of the final mobility module 300_1. The user terminal 400 may notify the user of the received estimated charge and the first travel time t corresponding to the travel from the current location of the final mobility module 300_1 to the call location, and may provide the screen for selecting whether to agree with the call of the final mobility module 300_1. When the user inputs a response to a question through the user terminal 400, the application installed in the user terminal 400 may transmit the input response to the control server 100 through the user terminal 400. The communication unit 130 may receive the response from the user terminal 400.

When the response received by the communication unit 130 from the user terminal 400 in the operation S605 is a response that does not agree with the call of the final mobility module 300_1 (No the operation S605), the operation S101 of FIG. 3 may be performed.

When the response received by the communication unit 130 from the user terminal 400 in the operation S605 is a response that agrees with the call of the final mobility module 300_1 (Yes in the operation S605), the call processor 123 may, in an operation S606, transmit a signal requesting prepayment of the estimated charge to the user terminal 400. The user may prepay the estimated charge through the user terminal 400.

When prepayment for the estimated charge is completed, the call processor 123 may, in an operation S607, transmit the call signal to the final mobility module 300_1. The call signal may include a move command instructing the final mobility module 300_1 to move to the call location.

After the final mobility module 300_1 moves to the call location according to the call signal, the battery of the final mobility module 300_1 and the battery of the place module 200 are connected at the call location, and the place module 200 may move from the call location to the destination (or final arrival location) while being coupled to the final mobility module 300_1 in an operation S608. The call processor 123 may receive a signal indicating a state where they are coupled to each other from the place module 200 and/or the final mobility module 300_1.

When the place module 200 arrives at the destination (or final arrival location) while being coupled with the final mobility module 300_1 in an operation S609, the call processor 123 may, in an operation, recalculate the actual charge required for traveling from the call location to the destination or final arrival location and request the user terminal 400 to recalculate the difference amount between the actual charge and the estimated charge. When the actual charge exceeds the estimated charge, the user may additionally pay the difference amount between the actual charge and the estimated charge through the user terminal 400. When the actual charge is less than the estimated charge, the user may cancel the prepayment for the estimated charge and then pay the actual charge through the user terminal 400 or partially cancel the payment for the difference amount obtained by subtracting the actual charge from the estimated charge.

When the recalculation of the actual charge is completed, the place module 200 and the final mobility module 300_1 may be separated in an operation S611. For example, when the recalculation of the actual charge is completed, the communication unit 130 receives a signal from the user terminal 400 indicating that the recalculation is completed, and accordingly, the call processor 123 may transmit a control signal to release the fixation of the connection part between the place module 200 and the final mobility module 300_1. Accordingly, the connection between the battery of the final mobility module 300_1 and the battery of the place module 200 may be released.

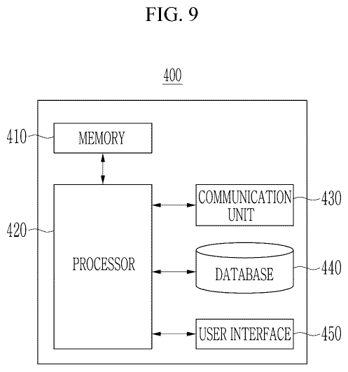

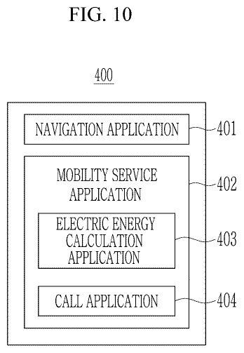

In the above description, it has been described that the entity providing the mobility service is the control server 100, but this is for the convenience of description and the present disclosure is not limited thereto. In another embodiment, some of the operations of the above-described control server 100 may be performed by the user terminal 400. Hereinafter, an embodiment in which some of the operations of the above-described control server 100 may be performed by the user terminal 400 is described in more detail below with reference to FIGS. 9 and 10.

According to an embodiment, the user terminal 400 may receive a signal indicating the call command from the user, may calculates the required electric energy A and the charging electric energy K according to the call command, and when the control server 100 searches for the plurality of candidate mobility modules, may determine whether to determine the target mobility module as one of the plurality of target mobility modules among the plurality of candidate mobility modules as the final mobility module.

FIG. 9 is a detailed configuration diagram of a user terminal in a mobility service providing system, according to an embodiment. FIG. 10 is a diagram schematically illustrating an application installed on a user terminal illustrated in FIG. 9, according to an embodiment.

Referring to FIG. 9, the user terminal 400 may include a memory 410, a processor 420, a communication unit 430, and a database 440.

Referring to FIG. 10, a navigation application 401 and a mobility service application 402 may be installed in the user terminal 400. The user terminal 400 may have a plurality of applications installed, including the navigation application 401 and the mobility service application 402. The user terminal 400 may transmit a call signal to the mobility module 300 based on a signal input by the user or a signal received from the search processor 122. The mobility service application 402 may include an electric energy calculation application 403 and a call application 404.

The memory 410 may store various programs and commands for providing a mobility service according to embodiments of the present disclosure. The program stored in the memory 410 may include a program for the processor 420 to execute each of the navigation application 401 and the mobility service application 402. The processor 420 may execute the program stored in the memory 410 to perform the following operations.

The signal received from the control server 100 to the user terminal 400 may be processed to obtain information by an application processor (AP) of the user terminal 400. The AP may transmit the corresponding information to the mobility service application 402 according to an embodiment. The processor 420 illustrated in FIG. 9 may include the AP. Hereinafter, the operation of the AP may be described as the operation of the processor 420.

The navigation application 401 and the mobility service application 402 may perform calculations based on information received from the AP, may display the calculation results on a user interface 450, and/or transmit the calculation results to the control server 100 through the user terminal 400.

The communication unit 430 may be a device that may transmit signals generated by each of the navigation application 401 and the mobility service application 402 to the outside through a network. Hereinafter, the communication unit 430 transmitting and receiving data to the outside is described as the user terminal 400 transmitting and receiving data to the outside.

The database 440 may store information on the control server 100, the place module 200, and the mobility module 300. The database 440 may include vehicle model information corresponding to the identification information of the preferred vehicle among the travel information input to the user interface 450.

The user interface 450 may receive a signal from the user and transmit the signal to the processor 420, and may provide the user with a screen received from the processor 420.

Hereinafter, the operations of each of the navigation application 401, the mobility service application 402, the electric energy calculation application 403, and the call application 404 may be performed based on the information received from the AP.

The above description of the electric energy calculation processor 121 may be equally applied to the electric energy calculation application 403 unless otherwise specifically stated. The above description of the call processor 123 may be equally applied to the call application 404 unless otherwise specifically stated.

The search processor 122 of the control server 100 may search for the plurality of candidate mobility modules within a predetermined distance based on the call location based on the signal indicating the call command received from the user terminal 400, and may transmit the signal indicating the search result to the user terminal 400.

The mobility service application 402 may receive a call command from a user through the user interface 450. The user interface 450 may receive a signal indicating a call command to move the place module 200 from the call location to the destination from the user, and may transmit the input signal to at least one of the navigation application 401 and the mobility service application 402. The user interface 450 may provide screens displayed by each of the navigation application 401 and the mobility service application 402. The user interface 450 may be implemented as an all-in-one display included in a display capable of one touch input.

The navigation application 401 may search for a route from the call location to the destination at the request of the mobility service application 402 or when a signal indicating a call command is input to the user interface 450. The navigation application 401 may provide a screen displaying the route searched through the user interface 450.

The navigation application 401 may provide traffic information for the mobility module 300 through the user interface 450. The traffic information provided by the navigation application 401 may include information such as route guidance and route search.

Hereinafter, the mobility providing system 1 may provide a mobility service that matches the mobility module 300 that moves the place module 200 to the place module 200 in response to the call command input into the user terminal 400.

The user interface 450 may provide a screen that displays the residual electric energy of the place module 200 in real time according to the user's settings.

When the call command is input from the user to the user interface 450, the mobility service application 402 may execute the navigation application 401 to request search for the travel route that moves the place module 200 from the call location to the destination. The navigation application 401 may search for the travel route from the call location to the destination according to the request from the mobility service application 402, and may transmit a signal indicating the travel route to the mobility service application 402. The travel route for travel from the call location to the destination may include a travel distance and a travel time according to the travel route from the call location to the destination.

The communication unit 430 may communicate with the control server 100, the place module 200, and the mobility module 300 through the network. The communication unit 430 may communicate with the place module 200 and receive residual electric energy R of the place module 200.

The electric energy calculation application 403 may calculate the required electric energy A for travel from the call location to the destination based on the call command. The electric energy calculation application 403 may calculate the required electric energy A corresponding to the travel distance and the travel time from the call location to the destination based on the signal received from the navigation application 401.

When the call command is input from the user to the user interface 450, the electric energy calculation application 403 may transmit a signal requesting a search for the mobility module around the call location (hereinafter, “search request signal”) to the control server 100. When the search request signal is received from the user terminal 400, the search processor 122 may search for the plurality of candidate mobility modules within a predetermined distance based on the call location. The search processor 122 may transmit the signal indicating the plurality of candidate mobility modules to the user terminal 400.

When the signal indicating the plurality of candidate mobility modules is received from the control server 100, the call application 404 may determine a target mobility module as one of the plurality of candidate mobility modules. The call application 404 may determine whether to determine the target mobility module as the final mobility module based on whether the residual electric energy of the target mobility module is equal to or greater than the predetermined reference value. The call application 404 may calculate the estimated charge for the mobility service based on the required electric energy. The call application 404 may calculate the estimated charge for the mobility service based on the required electric energy A calculated from the electric energy calculating application 403, and may generate the call signal for the final mobility module and transmit the generated call signal to the final mobility module. The call signal generated by the call application 404 may include a call location.

The user interface 450 may receive a call command from a user. When the call command is input, the communication unit 430 may communicate with the place module 200 to inquire the residual electric energy R of the place module 200, and the electric energy calculation application 403 may calculate the required electric energy A for travel from the call location to the destination based on the call command. The navigation application 401 may calculate the travel distance D and travel time T from the call location to the destination.

The electric energy calculation application 403 may transmit the control signal to the user interface 450 to inquire whether to request travel using the power of the place module 200. The user interface 450 may provide a screen for inquiring whether to move using the power of the place module 200. When the user inputs a response to the question through the user interface 450, the user interface 450 may transmit the input response to the mobility service application 402.

When the response input to the user interface 450 is a response to move using the power of the place module 200, the electric energy calculation application 403 may calculate the charging electric energy K based on the indoor power consumption α of the place module 200 during travel, the residual target electric energy β after travel, etc.

When the response input to the user interface 450 is a response that the power of the place module 200 is not used, the electric energy calculation application 403 may calculate the charging electric energy K as 0.

When the electric energy calculation application 403 calculates the charging electric energy K, the call application 404 may determine the final mobility module based on whether the residual electric energy of the target mobility module is equal to or greater than a predetermined reference value. The call application 404 may compare the required electric energy A and the charging electric energy K, and calculate the estimated charge for the call command based on the comparison result. The call application 404 may transmit the call signal to the final mobility module based on the estimated charge.

In relation to the operation of calculating the indoor power consumption α, the electric energy calculating application 403 may determine the indoor power mode of the place module 200 as one of the low-power mode, the intermediate mode, and the high-power mode according to the power consumption of the internal devices while the place module 200 moves from the call location to the destination.

The electric energy calculating application 403 may determine the driving mode based on the information input to the user interface 450 and calculate the residual target electric energy β after the travel of the place module 200. The driving mode may be one of a one-way mode, a round-trip mode, and a stay mode.

The communication unit 430 may receive the indoor power consumption record for the recent predetermined period from the place module 200. The electric energy calculating application 403 may calculate the average indoor power consumption E for the predetermined period based on the indoor power consumption record for the predetermined period. The electric energy calculation application 403 may select an indoor power mode corresponding to the calculated average indoor power consumption E. The electric energy calculation application 403 may finally determine the indoor power mode based on whether the user agrees with the indoor power mode selected in response to the average indoor power consumption E. The user interface 450 may provide a screen inquiring whether with agree to the indoor power mode selected from the power calculation processor 121. When the user inputs a response to the question through the user interface 450, the user interface 450 may transmit the input response to the mobility service application 402.

When the response input to the user interface 450 is a response agreeing with the selected indoor power mode, the electric energy calculation application 403 may determine the selected indoor power mode as the final indoor power mode. The electric energy calculation application 403 may calculate indoor power consumption α by multiplying the average indoor power consumption E by the travel time T.

When the communication unit 430 does not receive the indoor power consumption record from the place module 200, or when the response input to the user interface 450 is a response that does not agree with the selected indoor power mode, the electric energy calculation application 403 may transmit the control signal to the user interface 450 to request the user interface 450 to select an indoor power mode among the low-power mode, the intermediate mode, and the high-power mode. The user interface 450 may provide a screen for selecting an indoor power mode among the low-power mode, the intermediate mode, and the high-power mode. When the user selects and inputs one of the low-power mode, the intermediate mode, and the high-power mode through the user interface 450, the user interface 450 may transmit the input response to the mobility service application 402. In this case, the electric energy calculation application 403 may determine the indoor power mode according to the response input to the user interface 450 among the low-power mode, the intermediate mode, and the high-power mode as the final indoor power mode. The electric energy calculation application 403 may calculate the indoor power consumption α by multiplying the predetermined reference average electric energy according to the final indoor power mode determined by the travel time T.

The predetermined reference average electric energy may be stored in the database 440 as initial information in advance according to the indoor power mode being the low-power mode, the intermediate mode, and the high-power mode, respectively.

In relation to the operation of calculating the residual target electric energy β, the communication unit 430 may receive the recent driving mode record from the place module 200. When the recent driving mode record is received, the electric energy calculation application 403 may determine the driving mode identical to the recent driving mode record as the recommended driving mode. When the recent driving mode record is not received, the electric energy calculation application 403 may determine the recommended driving mode as one of the driving modes. For example, the electric energy calculation processor 121 may determine the recommended driving mode as the round-trip mode.

When the recommended driving mode is determined, the electric energy calculation application 403 may transmit the control signal to the user interface 450 to inquire whether to agree with the recommended mode. The user interface 450 may provide a screen to inquire whether to agree with the recommended driving mode. When the user inputs a response to the question through the user interface 450, the user interface 450 may transmit the input response to the mobility service application 402.

When the response input to the user interface 450 is a response that agrees with the selected recommended driving mode, the electric energy calculation application 403 may determine the recommended driving mode as the final driving mode. When the response input to the user interface 450 is a response that does not agree with the selected recommended driving mode, the electric energy calculation application 403 may transmit the control signal to the user interface 450 to request to select the driving mode among the mode, the round-trip mode, and stay mode. The user interface 450 may provide a screen for selecting the driving mode among the one-way mode, the round-trip mode, and the stay mode.

When the user inputs a response to the question through the user interface 450, the user interface 450 may transmit the input response to the mobility service application 402. The electric energy calculation application 403 may determine the driving mode according to the response input to the user interface 450 as the final driving mode. When the final driving mode is determined, the electric energy calculation application 403 may determine whether the final driving mode is the stay mode.

When the final driving mode is the stay mode, the electric energy calculation application 403 may transmit the control signal to the user interface 450 to request selection of the stay time M and the stay type. The user interface 450 may provide a screen for selecting the stay time M and the stay type. When a user inputs the stay time M and selects one of the low-power mode, the intermediate mode, and the high-power mode as the stay type, the user interface 450 may transmit the input response to the mobility service application 402. When receiving a signal indicating the stay time M and the stay type from the user interface 450, the electric energy calculation application 403 may calculate the power consumption γ during the stay by multiplying the stay time M according to the input response by a predetermined reference average electric energy according to the response of the stay type.

When the final driving mode is not the stay mode, or if the power consumption γ during the stay is calculated, the electric energy calculation application 403 may determine the reference SoC(s) of the mobility module 300.

When there is a SoC record at the time of connection of the mobility module 300 in the database 440, the electric energy calculation application 403 may calculate an average SoC of the SoC record and determine the calculated average SoC as the reference SoC(s) of the mobility module 300. The SoC record at the time of connection of the mobility module 300 may include the SoC of the battery of the coupled mobility module (e.g., 300_1) at each time point(s) when the place module 200 is coupled to one of the plurality of mobility modules 300_1 to 300_3.

Although the electric energy calculation application 403 is generally described herein as confirming whether there is a SoC record at the time of connection of the mobility module 300 in the database 440, this is for the convenience of description and the present disclosure is not limited thereto. For example, in some embodiments, the electric energy calculation application 403 may inquire whether there is a SoC record in the control server 100, and may confirm whether there is a SoC record at the time of connection based on the response.

When there is no SoC record at the time of connection of the mobility module 300 in the database 440, the electric energy calculation application 403 may determine the predetermined SoC value as the reference SoC(s). The electric energy calculation application 403 may calculate the residual target electric energy β based on the minimum target SoC value S included in the call command, the required electric energy A, the reference SoC(s) of the mobility module 300, and the indoor power consumption α according to the final driving mode.

When the final driving mode is the one-way mode, the electric energy calculation application 403 may determine the residual target electric energy β as the power value (β=S) corresponding to the minimum target SoC value S. Since the destination is the final arrival location in the one-way mode, the residual target electric energy β at the destination in the one-way mode is the power value corresponding to the minimum target SoC value S input by the user.

Therefore, when the final driving mode is the round-trip mode, the electric energy calculation application 403 may determine the residual target electric energy β as a value (β=α+A+S−s) obtained by subtracting the power value corresponding to the reference SoC(s) of the mobility module 300 from the sum of the power values corresponding to the indoor power consumption α, the required electric energy A, and the minimum target SoC value S.

When the final driving mode is the stay mode, the electric energy calculation application 403 may determine the residual target electric energy β as a value (β=γ+α+A+S−s) obtained by subtracting the power value corresponding to the reference SoC(s) from the sum of the power consumption γ during the stay, the indoor power consumption α, the required electric energy A, and the power value corresponding to the minimum target SoC value S.

When calculating the indoor power consumption α and the residual target electric energy β, the electric energy calculation application 403 may calculate the charging electric energy K as a value obtained by subtracting the indoor power consumption α and the residual target electric energy β from the residual electric energy R of the place module 200 (K=R−α−β).

The electric energy calculation application 403 may determine whether the sum of the charging electric energy K calculated by subtracting the indoor power consumption α and the residual target electric energy β from the residual electric energy R and the power value corresponding to the reference SoC(s) is less than the required electric energy A. When the sum of the charging electric energy K and the power value corresponding to the reference SoC(s) is greater than or equal to the required electric energy A, the electric energy calculation application 403 may transmit the control signal to the user interface 450 to inquire whether to agree with the charging electric energy (K=R−α−β) calculated by subtracting the indoor power consumption α and the residual target electric energy β from the residual electric energy R. The user interface 450 may provide a screen inquiring whether to agree with the calculated charging electric energy K. When the user inputs a response to the question through the user interface 450, the user interface 450 may transmit the input response to the mobility service application 402.

When the response input to the user interface 450 is a response that agrees with the charging electric energy (K=R−α−β) calculated by subtracting the indoor power consumption α and the residual target electric energy β from the residual electric energy R, the electric energy calculation application 403 may determine the calculated charging electric energy (K=R−α−β) as the final charging electric energy K.

When the response input to the user interface 450 is a response that does not agree with the charging electric energy (K=R−α−β) calculated by subtracting the indoor power consumption α and the residual target electric energy β from the residual electric energy R, the electric energy calculation application 403 may transmit the control signal to the user interface 450 to request the user interface 450 to input the charging electric energy within the range of R−α−β. The user interface 450 may provide a screen for inputting the charging electric energy. The minimum value of the charging electric energy that the user may input may be the larger value max[0, A−s] of the value obtained by subtracting the power value corresponding to the reference SoC(s) from the required electric energy A and 0. The maximum value of the charging electric energy that the user may input may be R−α−β.

When the user inputs the charging electric energy through the user interface 450, the user interface 450 may transmit the input response to the mobility service application 402. The electric energy calculation application 403 may determine the charging electric energy according to the response input to the user interface 450 as the final charging electric energy K. Hereinafter, the charging electric energy K may represent the final charging electric energy determined by the electric energy calculation application 403.

When the sum of the charging electric energy K and the power value corresponding to the reference SoC(s) is less than the required electric energy A, the call application 404 may change the destination to the charging station. The call application 404 may change a nearby charging station to a new destination based on the information input to the user interface 450.

When the electric energy calculating application 403 calculates the charging electric energy K, the call application 404 may determine the final mobility module. The call application 404 may receive the signal indicating the plurality of candidate mobility modules from the control server 100. Hereinafter, for convenience of description, the plurality of mobility modules 300_1 to 300_3 illustrated in FIG. 1 are assumed to be a plurality of candidate mobility modules according to an embodiment. The call application 404 may determine the candidate mobility module (e.g., 300_1) located closest to the call location among the plurality of candidate mobility modules 300_1 to 300_3 as the target mobility module.

The call application 404 may collect the residual electric energy r of the target mobility module 300_1. At the request of the call application 404, the communication unit 430 may transmit a signal inquiring about the residual electric energy r to the target mobility module 300_1. The communication unit 430 may receive the signal indicating the residual electric energy r from the target mobility module 300_1 in response to the inquiry.

The call application 404 may calculate the first required electric energy a for travel from the current location of the target mobility module 300_1 to the call location. When the residual electric energy r of the target mobility module 300_1 is collected, the call application 404 may execute the navigation application 401 to request search for the travel route for traveling the target mobility module 300_1 from the current location of the target mobility module 300_1 to the call location. The navigation application 401 may search for the travel route for traveling the target mobility module 300_1 from the current location of the target mobility module 300_1 to the call location according to the request of the call application 404, and transmit the signal indicating the travel route to the mobility service application 402. The travel route from the current location of the target mobility module 300_1 to the call location may include the first travel distance d and the first travel time t according to the travel route from the current location of the target mobility module 300_1 to the call location.

The call application 404 may determine whether the first travel distance d exceeds a predetermined maximum service distance. When the first travel distance d exceeds a predetermined maximum service distance, the call application 404 may transmit the control signal to the user interface 450 to notify that there is no available mobility module within the predetermined maximum service distance. The user interface 450 may perform a notification operation to notify that there is no available mobility module within the predetermined maximum service distance.

When the first travel distance d is less than or equal to the predetermined maximum service distance, the call application 404 may determine whether the value obtained by subtracting the first required electric energy a and the electric energy corresponding to the minimum SoC of the predetermined mobility module from the residual electric energy r of the target mobility module 300_1 is less than the value obtained by subtracting the charging electric energy K from the required electric energy A (r-a-minimum SoC of the mobility module<A−K). When the value obtained by subtracting the first required electric energy a and the electric energy corresponding to the minimum SoC of the predetermined mobility module from the residual electric energy r of the target mobility module 300_1 is less than the value obtained by subtracting the charging electric energy K from the required electric energy A (r-a-minimum SoC of the mobility module<A−K), the call application 404 may determine the remaining candidate mobility modules 300_2 and 300_3 excluding the target mobility module 300_1 among the plurality of candidate mobility modules 300_1 to 300_3 as the plurality of new candidate mobility modules. Here, the value obtained by subtracting the first required electric energy a from the residual electric energy r and the electric energy corresponding to the minimum SoC of the predetermined mobility module is less than the value obtained by subtracting the charging electric energy K from the required electric energy A (r-a-minimum SoC of the mobility module<A−K), which may be the case where the residual electric energy of the target mobility module 300_1 described above is less than a predetermined reference value.

The call application 404 may transmit the signal indicating that the target mobility module 300_1 is excluded from the plurality of candidate mobility modules to the control server 100.

When the remaining candidate mobility modules 300_2, 300_3 are determined as new plurality of candidate mobility modules, the call application 404 may determine a new target mobility module based on the plurality of new candidate mobility modules 300_2, 300_3.

When the value obtained by subtracting the first required electric energy a and the electric energy corresponding to the minimum SoC of the predetermined mobility module from the residual electric energy r of the target mobility module 300_1 is greater than or equal to the value obtained by subtracting the charging electric energy K from the required electric energy A (r-a-minimum SoC of the mobility module≥A−K), the call application 404 may determine the target mobility module as the final mobility module. Here, the value obtained by subtracting the first required electric energy a and the electric energy corresponding to the minimum SoC of the predetermined mobility module from the residual electric energy r is greater than or equal to the value obtained by subtracting the charging electric energy K from the required electric energy A (r-a-minimum SoC of the mobility module≥A−K), which may be the case where the residual electric energy of the target mobility module 300_1 described above is greater than or equal to the predetermined reference value.

The call application 404 may match the determined final mobility module to the place module 200. Hereinafter, for the convenience of description, the final mobility module is described as the mobility module 300_1.

The call application 404 may transmit the call signal to the final mobility module 300_1. When the call processor 123 determines the final mobility module 300_1, it calculates the estimated charge for using the final mobility module 300_1, notifies the user of the calculated charge, and then determines a call to the final mobility module 300_1. The call application 404 may calculate the estimated charge based on the difference between the charging electric energy K and the required electric energy A.

The call application 404 may determine whether the charging electric energy K is greater than the required electric energy A. When the charging electric energy K is equal to the required electric energy A, the estimated charge may be a predetermined basic charge. The call application 404 may calculate the basic charge as a value obtained by multiplying the distance used for the mobility service by the predetermined unit rate per unit electric energy. Although it is generally described herein that the call application 404 calculates the basic charge by multiplying the unit rate per unit electric energy by the distance using the mobility service, this is for the convenience of description and the present disclosure is not limited thereto. For example, in some embodiments, the call application 404 may determine a predetermined amount set as initial information as the basic charge.

When the charging electric energy K is equal to or less than the required electric energy A, the call application 404 may calculate the estimated charge in the uncharging travel mode. In the uncharging travel mode, the user terminal 400 may not perform additional charging of the final mobility module 300_1, and therefore may not receive a discount on the rate according to the additional charging. The call application 404 may calculate the estimated charge of the uncharging travel mode as the amount (basic charge+predetermined additional charge rate per unit electric energy [KRW/kWh]*A−K) obtained by multiplying a value obtained by adding the basic charge to the predetermined additional charge per unit electric energy by the value obtained by subtracting the charging electric energy K from the required electric energy A.

When the charging electric energy K is greater than the required electric energy A, the call application 404 may calculate the estimated charge in the charging travel mode. In the charging travel mode, the user terminal 400 may perform the additional charging of the final mobility module 300_1 using the surplus electric energy and receive a rate discount.

The call application 404 may calculate the additional charging amount C to be provided by the place module 200 to the final mobility module 300_1 based on a surplus electric energy value obtained by subtracting the required electric energy A from the charging electric energy K. The call application 404 may calculate the additional charging amount C as the smallest value (C=min[(predetermined charging amount per hour)*T, K−A, (predetermined maximum charging amount of mobility module)−r−a]) among a value obtained by multiplying the travel time T from the call location to the destination by the predetermined charging amount per hour, a value obtained by subtracting the required electric energy A from the charging electric energy K, and a value obtained by subtracting the residual electric energy r of the final mobility module 300_1 and the first required electric energy corresponding to the travel from the current location of the final mobility module 300_1 to the call location from the predetermined maximum charging amount of the mobility module 300.

The call application 404 may calculate the estimated charge of the charging travel mode as the amount (basic charge−charging discount rate per predetermined unit electric energy [won/kWh]*charging amount C [kWh]) obtained by subtracting the value obtained by multiplying the charging discount rate per predetermined unit electric energy by the additional charging amount C from the basic charge.

When the call application 404 calculates the estimated charge of the uncharged use mode or the charging use mode, the call application 404 may transmit the calculated estimated charge and the first travel time t corresponding to the travel from the current location of the final mobility module 300_1 to the call location to the user interface 450, and transmit the control signal to inquire about the call of the final mobility module 300_1. The user interface 450 may notify the user of the estimated charge and the first travel time t corresponding to the travel from the current location of the final mobility module 300_1 to the call location, and may provide the screen for selecting whether to agree with the call of the final mobility module 300_1. When the user inputs a response to the question through the user terminal 400, the user interface 450 may transmit the input response to the mobility service application 402.

When the response input to the user interface 450 is a response not to agree with the call of the final mobility module 300_1, the call application 404 may transmit the control signal to allow the user interface 450 to input a new call command.

When the response is a response to agree with the call of the final mobility module 300_1, the call application 404 may transmit the control signal to request prepayment for the estimated charge to the user interface 450. The user interface 450 may provide a screen for performing payment for the estimated charge. The user may prepay the estimated charge through the user interface 450.

When the prepayment for the estimated charge is completed, the call application 404 may transmit the call signal to the final mobility module 300_1. The call signal may include a travel command instructing the final mobility module 300_1 to travel to the call location.

After the final mobility module 300_1 travels to the call location according to the call signal, the battery of the final mobility module 300_1 and the battery of the place module 200 are connected at the call location, and the place module 200 may travel from the call location to the destination (or final arrival location) while being coupled to the final mobility module 300_1. The call application 404 may receive a signal indicating that they are coupled to each other from the place module 200 and/or the final mobility module 300_1.

When the place module 200 arrives at the destination (or final arrival location) while being coupled with the final mobility module 300_1, the call application 404 may recalculate the actual charge required for travel from the call place to the destination (or final arrival location) and transmit the control signal to the user interface 450 to request the recalculation of the difference between the actual charge and the expected charge.

The user interface 450 may provide a screen that allows recalculation of the difference between the actual charge and the estimated charge. The user may recalculate the difference between the actual charge and the estimated charge through the user interface 450. When the actual charge exceeds the estimated charge, the user may additionally pay the difference between the actual charge and the estimated charge through the user interface 450. When the actual charge is less than the estimated charge, the user may cancel the prepayment for the estimated charge and pay the actual charge through the user interface 450 or partially cancel the payment for the difference obtained by subtracting the actual charge from the estimated charge.

When the recalculation of the actual charge is completed, the place module 200 and the final mobility module 300_1 may be separated. For example, when the recalculation of the actual charge is completed, the call application 404 transmits the signal to the control server 100 notifying that the use of the mobility service has ended, and the fixation of the connection part between the place module 200 and the final mobility module 300_1 may be released according to the control signal of the control server 100. Accordingly, the connection between the battery of the final mobility module 300_1 and the battery of the place module 200 may be released.

Although some embodiments of the present disclosure have been described in detail above, the scope of the present disclosure is not limited thereto, and various modifications and improvements by those of ordinary skill in the art to which the present disclosure pertains belong to the scope of the present disclosure.

What is claimed is:

1. A mobility service providing system comprising:
a communication interface configured to receive, from a user terminal, a call command requesting transportation of a place module by a mobility module from a call location to a destination; and
a processor configured to:
determine a required electric energy for travel from the call location to the destination,
determine a charging electric energy to be provided by the place module to the mobility module,
determine a plurality of candidate mobility modules within a predetermined distance of the call location,
determine a target mobility module, among the plurality of candidate mobility modules, as a final mobility module based on determining that a residual electric energy of the target mobility module satisfies a predetermined reference value condition,
determine an estimated charge for the call command based on a result of comparing the required electric energy and the charging electric energy, and
transmit a call signal to the final mobility module based on the estimated charge.

2. The mobility service providing system of claim 1, wherein the processor is configured to, based on determining that the charging electric energy is less than or equal to the required electric energy, determine the estimated charge by adding i) a value obtained by multiplying a value obtained by subtracting the charging electric energy from the required electric energy by predetermined additional charge rate per unit electric energy to ii) a predetermined basic charge.

3. The mobility service providing system of claim 1, wherein the processor is configured to:
based on determining that the charging electric energy is greater than the required electric energy, determine the estimated charge by
determining an additional charging amount that the place module is to provide to the final mobility module as a smallest value among
a value obtained by multiplying a travel time from the call location to the destination by a predetermined charging amount per hour,
a value obtained by subtracting the required electric energy from the charging electric energy, and
a value obtained by subtracting residual electric energy of the final mobility module and required electric energy corresponding to travel from a current location of the final mobility module to the call location from a maximum charging amount of a predetermined mobility module, and
determining the estimated charge by subtracting i) a value obtained by multiplying the additional charging amount by a predetermined charging discount charge rate from ii) a predetermined basic charge.

4. The mobility service providing system of claim 1, wherein the processor is configured to:
determine a candidate mobility module that is located closest to the call location among the plurality of candidate mobility modules as the target mobility module;
collect a first residual electric energy of the target mobility module from the target mobility module;
determine a first travel distance, a first travel time, and a first required electric energy corresponding to the first travel distance and the first travel time from a current location of the target mobility module to the call location; and
determine whether to select the target mobility module as the final mobility module based on determining whether i) a first value obtained by subtracting the first required electric energy and electric energy corresponding to a minimum state of charge (SoC) of a predetermined mobility module from the first residual electric energy is less than ii) a second value obtained by subtracting the charging electric energy from the required electric energy, based on determining that the first travel distance is less than or equal to a predetermined maximum service distance.

5. The mobility service providing system of claim 4, wherein the processor is configured to:
based on determining that the first value is less than the second value,
determine remaining candidate mobility modules, among the plurality of candidate mobility modules, excluding the target mobility module as a plurality of new candidate mobility modules, and
determine the mobility module located closest to the call location among the plurality of new candidate mobility modules as a new target mobility module.

6. The mobility service providing system of claim 4, wherein the processor is configured to, based on determining that the first value is greater than or equal to the second value, determine the target mobility module as the final mobility module.

7. The mobility service providing system of claim 1, wherein the processor is configured to, based on receiving, from the user terminal, a response indicating that power of the place module is to be used for the transportation of the place module, determine the charging electric energy by subtracting indoor power consumption of the place module during the transportation of the place module and a residual target electric energy at the destination from residual electric energy of the place module.

8. The mobility service providing system of claim 7, wherein the processor is configured to:
determine an indoor power mode of the place module as one of a low-power mode, an intermediate mode, or a high-power mode according to power consumption of internal devices installed in the place module; and
determine the indoor power consumption by multiplying a travel time from the call location to the destination by a predetermined reference average electric energy according to the indoor power mode,
wherein
a first reference average electric energy corresponding to the indoor power mode being the low-power mode is less than a second reference average electric energy corresponding to the indoor power mode being the intermediate mode, and
the second reference average electric energy is less than a third reference average electric energy corresponding to the indoor power mode being the high-power mode.

9. The mobility service providing system of claim 7, wherein the processor is configured to:
determine a driving mode based on information received from the user terminal; and
determine the residual target electric energy based on the driving mode, the indoor power consumption, the required electric energy, and a minimum target SoC received from the user terminal,
wherein the driving mode is one of a one-way mode for traveling from the call location to the destination, a round-trip mode for traveling from the call location to the destination and returning to the call location, or a stay mode for traveling from the call location to the destination, staying at the destination for a stay time, and returning from the destination to the call location.

10. The mobility service providing system of claim 9, wherein the processor is configured to, based on determining that the driving mode is the one-way mode, determine the residual target electric energy as the electric energy corresponding to the minimum target SoC.

11. The mobility service providing system of claim 9, wherein the processor is configured to, based on determining that the driving mode is the round-trip mode, determine the residual target electric energy by subtracting electric energy corresponding to a predetermined reference SoC from a sum of the indoor power consumption, the required electric energy, and electric energy corresponding to the minimum target SoC.

12. The mobility service providing system of claim 9, wherein the processor is configured to, based on determining that the driving mode is the stay mode,
determine power consumption during the stay time by multiplying the stay time by a predetermined reference average electric energy according to a stay type being one of a low-power mode, an intermediate mode, and a high-power mode,
determine the residual target electric energy by subtracting electric energy corresponding to a predetermined reference SoC from a sum of the power consumption during the stay time, the indoor power consumption, the required electric energy, and electric energy corresponding to the minimum target SoC, and
determine the power consumption during the stay time by multiplying the stay time by a predetermined reference average electric energy according to the stay mode,
wherein
a first reference average electric energy corresponding to the stay type being the low-power mode is less than a second reference average electric energy corresponding to the stay type being the intermediate mode, and
the second reference average electric energy is less than a third reference average electric energy corresponding to the stay type being the high-power mode.

13. A service providing system comprising:
a user interface configured to operate on a user terminal, the user interface configured to receive a call command, input by a user, requesting to transport a place module by a mobility module from a call location to a destination; and
a processor of the user terminal, the processor configured to
determine electric energy for travel from the call location to the destination,
receive a signal from a control server indicating a plurality of candidate mobility modules within a predetermined distance of the call location,
determine whether to select a target mobility module, among the plurality of candidate mobility modules, as a final mobility module based on determining whether residual electric energy of the target mobility module satisfies a predetermined reference value condition,
determine an estimated charge for the call command based on a result of comparing a required electric energy and a charging electric energy, and
transmit a call signal to the final mobility module based on the estimated charge.

14. A mobility service providing method comprising:
receiving, by a processor, a signal indicating a call command from a user terminal, the call command requesting transportation of a place module by a mobility module from a call location to a destination;
determining, by the processor, required electric energy for travel from the call location to the destination;
determining, by the processor, charging electric energy to be provided by the place module to the mobility module;
determining, by the processor, a plurality of candidate mobility modules within a predetermined distance of the call location;
determining, by the processor, whether to determine a target mobility module, among the plurality of candidate mobility modules, is eligible for selection as a final mobility module based on determining whether residual electric energy of the target mobility module satisfies a predetermined reference value condition;
determining the final mobility module among the plurality of candidate mobility modules based on locations of each of the plurality of candidate mobility modules and first residual electric energy of each of the plurality of candidate mobility modules;
calculating an estimated charge for the call command based on a result of comparing the required electric energy and the charging electric energy; and
transmitting a call signal to the final mobility module based on the estimated charge.

15. The mobility service providing method of claim 14, wherein determining the estimated charge includes, based on determining that the charging electric energy is less than or equal to the required electric energy, determining the estimated charge by adding i) a predetermined additional charge rate per unit electric energy multiplied by a value obtained by subtracting the charging electric energy from the required electric energy to ii) a predetermined basic charge.

16. The mobility service providing method of claim 14, wherein determining the estimated charge includes, based on determining that the charging electric energy is greater than the required electric energy,
determining an additional charging amount that the place module is to provide to the final mobility module as a smallest value among
a value obtained by multiplying a travel time from the call location to a destination by a predetermined charging amount per hour,
a value obtained by subtracting the required electric energy from the charging electric energy, and
a value obtained by subtracting residual electric energy of the final mobility module and required electric energy corresponding to travel from a current location of the final mobility module to the call location from a maximum charging amount of a predetermined mobility module; and
determining the estimated charge by subtracting a value obtained by multiplying a charging amount by a predetermined charging discount charge rate from a predetermined basic charge.

17. The mobility service providing method of claim 14, further comprising:
determining, by the processor, a candidate mobility module located closest to the call location among the plurality of candidate mobility modules as the target mobility module;
collecting, by the processor, the first residual electric energy of the target mobility module from the target mobility module;
determining, by the processor, a first travel distance, a first travel time, and a first required electric energy corresponding to the first travel distance and the first travel time from a current location of the target mobility module to the call location; and
based on determining that the first travel distance is less than or equal to a predetermined maximum service distance, determining, by the processor, whether to select the target mobility module as the final mobility module based on determining whether a first value obtained by subtracting the first required electric energy and the electric energy corresponding to a minimum SoC of a predetermined mobility module from the first residual electric energy is less than a second value obtained by subtracting the charging electric energy from the required electric energy.

18. The mobility service providing method of claim 17, further comprising:
based on determining that the first value is less than the second value obtained by subtracting the charging electric energy from the required electric energy,
determining remaining candidate mobility modules, among the plurality of candidate mobility modules, excluding the target mobility module as a plurality of new candidate mobility modules, and
determining a mobility module located closest to the call location among the plurality of new candidate mobility modules as a new target mobility module.

19. The mobility service providing method of claim 17, further comprising based on determining that the first value is greater than or equal to the second value, determining the target mobility module as the final mobility module.

20. The mobility service providing method of claim 14, further comprising, based on receiving a response from the user terminal indicating that power of the place module is to be used for the travel, determining the charging electric energy by subtracting indoor power consumption of the place module during the travel and a residual target electric energy at the destination from residual electric energy of the place module.
